(19) United States
(12) Patent Application Publication
(10) Pub. No.: US 2007/0047038 A1
(43) Pub. Date: Mar. 1, 2007

(54) Hologram recording method, hologram recording material, optical recording medium

(75) Inventor: Hiroo Takizawa, Kanagawa (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/509,563

(22) Filed: Aug. 25, 2006

(30) Foreign Application Priority Data
Aug. 26, 2005 (JP) P2005-246313

(51) Int. Cl. G03H 1/02

(52) U.S. Cl. 359/3

(57) ABSTRACT

A hologram recording method is provided and includes: a first step of forming a latent image in a hologram recording material by holographic exposure; a second step of subjecting the hologram recording material having the latent image to heat treatment so as to form interference fringes providing a refractive index modulation; and a third step of irradiating the hologram recording material entirely with light to fix the interference fringes. A hologram recorded by the hologram recording method can be reproduced without erasing the refractive index modulation.

### BACKGROUND OF TEE INVENTION

1. Field of the Invention

The present invention relates to a hologram recording material and hologram recording method which can be applied to high density optical recording medium, three-dimensional display, holographic optical element, etc.

2. Description of Background Art

The general principle of preparation of hologram is described in some literatures and technical books, e.g., Junpei Tsujiuchi, “Holographic Display”, Sangyo Tosho, Chapter 2. In accordance with these literatures and technical books, a recording object is irradiated with one of two fluxes of coherent laser beams and a photosensitive hologram recording material is disposed in a position such that all the light beams reflected by the recording object can be received. Besides the light beam reflected by the recording object, the other coherent light beam is incident on the hologram recording material without hitting the object. The light beam reflected by the object is called object light. The light beam with which the hologram recording material is directly irradiated is called reference light. Interference fringes of reference light with object light arc then recorded as image data. Subsequently, when the hologram recording material thus processed is irradiated with the same light beam (reproducing light beam) as the reference light, the hologram performs diffraction in such a manner that the wave front of the first reflected light which has reached the recording material from the object during recording is reproduced. As a result, substantially the same object image as the real image of the, object can be three dimensionally observed.

The hologram formed by allowing reference light beam and object light beam to be incident on the hologram recording material in the same direction is called transmission hologram. The interference fringes are formed in the direction perpendicular or substantially perpendicular to the surface of the recording material at an interval of from about 1,000 to 3,000 lines per mm.

On the other hand, the hologram formed by allowing reference light beam and object light beam to be incident on the hologram recording material in opposite directions is normally called reflection hologram. The interference fringes are formed in the direction parallel to or substantially parallel to the surface of the recording material at an interval of from about 3,000 to 7,000 lines per mm.

The transmission hologram can be prepared by any known method as disclosed in JP-A-6-43634. The reflection hologram can be prepared by any known method as disclosed in JP-A-2-3082, JP-A-3-50588, etc.

On the other hand, the hologram having a sufficiently thick layer relative to the interval of interference fringes (normally five times the interval of interference fringes or about 1 μm or more) is called volume hologram.

On the contrary, the hologram having a layer thickness which is five times or less the interval of interference fringes or about 1 μm or less is called plane or surface hologram.

Further, the hologram involving the absorption by dye or silver causing die recording of interference fringes is called amplified hologram. The hologram involving recording by surface relief or refractive index modulation is called phase hologram. The amplified hologram is subject to drastic drop of light diffraction efficiency or reflectance due to absorption of light and thus is disadvantageous in percent utilization of light. In general, the phase hologram is preferably used.

In accordance with the volume phase type hologram, many interference fringes having different refractive indexes are formed in the hologram recording material without by making optical absorption, making it possible to modulate the phase of light without absorbing light.

In particular, the reflection volume phase type hologram is also called Lipman type hologram. In accordance with the reflection volume phase type hologram, wavelength-selective reflection involving Bragg diffraction allows the formation of full-color image, reproduction of white color and enhancement of resolution at a high diffraction efficiency, making it possible to provide a high resolution full-color three-dimensional display.

In recent years, hologram has been put into practical use in the art of holographic optical clement (HOE) such as headup display (HUD) to be mounted on automobile, pickup lens for optical disc, head mount display, color filter for liquid crystal and reflection type liquid crystal reflector by making the use of its wavelength-selective reflectivity. Studies have been made also on the practical use or application of hologram to lens, diffraction grating, interference filter, connector for optical fiber, light polarizer for facsimile, window glass for building, etc.

In the recent tend for highly informative society, networks such as internet and highvision TV have been rapidly spread. Further, with the operation of HDTV (high definition television) close at hand, there has been a growing demand for high density recording medium for simply recording image data having a capacity of 100 GB or more at reduced cost also in consumers' use.

In the trend for enhancement of computer capacity, an ultrahigh density recording medium capable of recording data having a capacity of about 1 TB or more at a high rate and reduced cost has been desired also in business uses such as computer backup and broadcast backup.

Under these circumstances, replaceable and random-accessible small-sized inexpensive optical recording media have been noted more than ever relative to magnetic tapes, which are not random-accessible, and hard discs, which are not replaceable and are subject to failure. Speaking from the standpoint of physical principle, however, existing two-dimensional optical recording media such as DVD-R allow recording of 25 GB data at greatest per one side even if the wavelength of the recording light bean is reduced. Thus, these two-dimensional recording media cannot be expected to have a recording capacity great enough to meet the future demand.

Then, three-dimensional optical recording media which perform recording in the thickness direction have been recently noted as ultimate ultrahigh density recording media. Effective methods for this system include method involving the use of two-photon absorbing material and method involving the use of holography (interference). Therefore, volume phase type hologram recording materials have recently been suddenly noted as three-dimensional optical recording media (holographic memory).

In operation, the holographic memory comprising a volume phase type hologram recording material records many two-dimensional digital data (called signal light) using a spatial light modulation element (SLM) such as DMD and LCD instead of object light reflected by the three-dimensional object. Since the recording involves multiplexed recording such as angle-multiplexed recording, phase-multiplexed recording, wavelength-multiplexed recording and shift-multiplexed recording, a capacity as high as up to 1 TB can be attained. Further, reading is normally accomplished by the use of CCD, CMOS or the like. These elements allow parallel writing/reading, making it possible to raise the transfer rate up to 1 Gbps.

However, the hologram recording materials to be used in holographic memory have severer requirements than for the three-dimensional display and HOE as follows.
(1) To have a high sensitivity.
(2) To have a high resolution.
(3) To have a high hologram diffraction efficiency.
(4) To use a fast dry processing during recording.
(5) To allow multiplexed recording (broad dynamic range).
(6) To have a small shrinkage after recording.
(7) To have good hologram storage properties.

In particular, the requirements (1) (To have a high sensitivity), (3) (To have a high hologram diffraction efficiency), (4) (To use a fast dry processing during recording), (6) (To have a small shrinkage after recording) and (7) (To have good hologram storage properties) are chemically opposing properties. It is very difficult to meet these requirements at the same time.

Examples of known volume phase type hologram recording materials include write-once-read-many type hologram recording materials such as gelatin bichromate process hologram recording material, bleached silver halide process hologram recording material and photopolymer process hologram recording material and rewritable type hologram recording materials such as photorefractive process hologram recording material and photochromic polymer process hologram recording material.

However, none of these known volume phase type hologram recording materials cannot meet all these requirements particularly when used as high sensitivity optical recording medium. Thus, these known volume phase type hologram recording materials leave something to be desired.

In some detail, the gelatin bichromate process hologram recording material is advantageous in that it has a high diffraction efficiency and a low noise but is disadvantageous in that it has extremely poor storage properties, requires wet processing and exhibits a low sensitivity. Thus, the gelatin bichromate process hologram recording material is not suitable for holographic memory.

The bleached silver halide process hologram recording material is advantageous in that it has a high sensitivity but is disadvantageous in that it requires wet processing and troublesome bleaching process, causes great scattering and has a poor light-resistance. Thus, the bleached silver halide process hologram recording material, too, is not suitable for holographic memory.

The photorefractive hologram recording material is advantageous in that it is rewritable but is disadvantageous in that it requires the application of a high electric field during recording and has poor record storage properties.

The photochromic polymer process hologram recording material such as azobenzene polymer process hologram recording material is advantageous in that it is rewritable but is disadvantageous in that it has an extremely low sensitivity and poor record storage properties. For example, WO97/44365A1 proposes a rewritable hologram recording material utilizing the refractive anisotropy and orientation control of azobenzene polymer (photochromic polymer). However, this type of a rewritable hologram recording material is disadvantageous in that since the quantum yield of isomerization of azobenzene is low and this process involves orientation change, the sensitivity is extremely low. This type of a rewritable hologram recording material is also disadvantageous in that it has poor record storage properties, which are contrary to rewritability. Thus, this type of a rewritable hologram recording material cannot be put into practical use.

Under these circumstances, the dry-processed photopolymer process hologram recording material disclosed in JP-A-6-43634, JP-A-2-3082 and JP-A-3-50588 has the following arrangement. In other words, the dry-processed photopolymer process hologram recording material is essentially composed of a binder, a radical-polymerizable monomer and a photopolymerization initiator. In order to enhance refractive index modulation, one of the binder and the radical-polymerizable monomer comprises a compound having an aromatic ring, chlorine or bromine incorporated therein to make a difference in refractive index therebetween. In this arrangement the holographic exposure causes the progress of polymerization with the monomer and the binder gathering at the bright area and the dark area of the interference fringes thus formed, making it possible to form a refractive index difference. Thus, it can be said that the dry-processed photopolymer process hologram recording material is a relatively practical hologram recording material which can attain a high diffraction efficiency and dry processing properties at the same time.

However, the dry-processed photopolymer process hologram recording material is disadvantageous in that it has a sensitivity of about one thousandth of that of the bleached silver halide process hologram recording material, requires a heat-fixing step for about 2 hours to enhance diffraction efficiency, requires radical polymerization causing the effect of polymerization inhibition by oxygen and is subject to shrinkage after exposure and fixing and hence change of diffraction wavelength and angle during reproduction. Further, the dry-processed photopolymer process hologram recording material is in the form of soft membrane and lacks storage properties. Accordingly, the dry-processed photopolymer process hologram recording material can be by no means used for holographic memory.

In general, as opposed to radical polymerization, cationic polymerization, particularly cationic polymerization involving the ring opening of an epoxy compound, etc., causes little shrinkage after polymerization and no polymerization inhibition by oxygen. As a result, a rigid membrane can be given. It is also pointed out that cationic polymerization is more suitable for holographic memory than radical polymerization.

For example, JP-A-5-107999 and JP-A-8-16078 disclose a hologram recording material comprising in combination a cationically-polymerizable compound (monomer or oligomer) instead of binder and a sensitizing dye, a radical polymerization initiator, a cationic polymerization initiator and a radical-polymerizable compound.

Further, JP-T-2001-523842 and JP-T-11-512847 disclose a hologram recording material comprising only a sensitizing dye, a cationic polymerization initiator, a cationically-polymerizable compound and a binder but free from radical polymerization.

The aforementioned cationic polymerization process hologram recording material shows some improvement in shrinkage resistance as compared with the radical polymerization process hologram recording material but has a lowered sensitivity as opposed to the improvement. It is thought that this disadvantage gives a great problem in transfer rate during practical use. Further, the cationic polymerization process hologram recording material exhibits a reduced diffraction efficiency that probably gives a great problem in SIN ratio and multiplexed recording properties.

As previously mentioned, the photopolymer process hologram recording method involves the movement of materials. This causes a dilemma. In some detail, when the hologram recording material to be applied to holographic memory is arranged to have better storage properties and shrinkage resistance, the resulting sensitivity is lowered (cationic polymerization process hologram recording material). On the contrary, when the hologram recording material is arranged to have an enhanced sensitivity, the resulting storage properties and shrinkage resistance are deteriorated (radical polymerization process hologram recording material). In order to enhance the recording density of holographic memory, it is essential that multiplexed recording involving more than 50 times, preferably 100 times or more recording jobs be effected. However, since the photopolymer process hologram recording material employs polymerization process involving the movement of materials to perform recording, the recording speed in the latter half of multiplexed recording process, in which most of the compound has ben polymerized, is reduced as compared with that in the initial stage of multiplexed recording process. Accordingly, exposure must be adjusted and a broad dynamic range must be used to control the recording speed. This gives a practically great problem.

The dilemma caused by the requirements for higher sensitivity, better storage properties and dry processing properties and the problem of multiplexed recording properties (high recording density) cannot be avoided from the physical standpoint of view so far as the related art photopolymer process hologram recording material is used. It is also difficult for the silver halide process recording material in principle from the standpoint of dry processing properties to meet the requirements for holographic memory.

In order to apply a hologram recording material to holographic memory, it has been keenly desired to develop quite a new recording system which can give essential solution to these problems, particularly one which can attain higher sensitivity, lower shrinkage, better storage properties, dry processing properties and multiplexed recording properties (high recording density) at the same time.

In general image recording methods, various dry type image recording methods involving no use of a liquid developer or other agents and hence causing no generation of wastes have been heretofore studied. In particular, image recording methods involving the use of a photosetting composition have been noted. These image recording methods arc characterized by a process which comprises exposing the recording material to light so that the photosetting composition contained in the recording material is cured to form a latent image while a component contained in the exposed area of the recording material which acts on color development or color extinction when heated moves through the interior of the recording material to form a color image. In the case where this type of a recording material is used, the recording material is exposed to light from laser or the like so that the exposed area is cured to form a latent image. The recording material is then heated so that the component contained in the uncured area (unexposed area) which acts on color development or color extinction moves to form a visible image. In accordance with this method, a full dry system causing no generation of wastes can be realized. For the details of these image recording methods, reference can be made to JP-A-2001-159825 and JP-A-2002-82431.

However, no examples of application of these image recording methods to hologram recording method and hologram recording material have been described.

### SUMMARY OF THE INVENTION

An object of an illustrative, non-limiting embodiment of the invention is to provide a hologram recording material and hologram recording method which can be applied to high density optical recording medium, three-dimensional display, hologram optical element, etc. and can attain a high sensitivity, high diffraction efficiency, good storage properties, low shrinkage factor, dry processing properties and multiplexed recording properties (high recording density) at the same time. Another object of an illustrative, non-limiting embodiment of the invention is to provide a hologram recording material and hologram recording method excellent in dry-process ability and storage properties.

As a result of extensive studies by the inventors, the aforementioned objects of the invention can be accomplished by the following constitutions.

(1) A hologram recording method comprising the steps of;

a first step of forming a latent image in a hologram recording material by holographic exposure;

a second step of subjecting the hologram recording material having the latent image to heat treatment so as to form interference fringes providing a refractive index modulation; and

a third step of irradiating the hologram recording material entirely with light to fix the interference fringes,

wherein a hologram recorded by the hologram recording method can be reproduced without erasing the refractive index modulation.

(2) The hologram recording method as defined in Clause (1), wherein a light source in the holographic exposure of the first step is a laser.

(3) The hologram recording method as defined in Clause (1) or (2), wherein a light source in the irradiation of the third step is at least one selected from the group consisting of laser, LED, flash lamp, fluorescent lamp, xenon lamp and mercury vapor lamp.

(4) The hologram recording method as defined in any one of Clauses (1) to (3), wherein the hologram recording material comprises a photopolymerizable composition, the photopolymerzable composition comprising: a photopolymerizable compound having an ethylenically unsaturated bond; and a photopolymerization initiator.

(5) The hologram recording method as defined in any one of Clauses (1) to (4), wherein the hologram recording material comprises a support and a photosensitive and thermosensitive recording layer comprising a photopolymerizable composition, the photopolymerizable composition comprising:
a thermo-responsive microcapsule containing a component A therein, the component A being one of a color-developable component and a color-extinguishable component (hereinafter, sometimes referred to as “a color-developable or color-extinguishable compound A”);
a compound B that is substantially colorless, the compound B comprising, in the same molecule of the compound B, an ethylenically unsaturated bond and a site that reacts with the component A to cause color development or color extinction of the component A; and
a photopolymerizable initiator, and wherein

the photopolymerizable composition is subjected to the holographic exposure at the first step to form the latent image,

the heat treatment at the second step causes color development or color extinction of the component A in accordance with the latent image to form the interference fringes, and

the photosensitive and thermosensitive recording layer is irradiated entirely with light at the third step to decolor the photopolymerization initiator so that the interference fringes are fixed.

(6) The hologram recording method as defined in any one of Clauses (1) to (4), wherein the hologram recording material comprises a support and a photosensitive and thermosensitive recording layer comprising a photopolymerizable composition, the photopolymerizable composition comprising:
a thermo-responsive microcapsule containing a color-developable or color-extinguishable component A therein, the component A being one of a color-developable component and a color-extinguishable component;
a component C that is substantially colorless and reacts with the component A to cause color development or color extinction of the component A;
a compound D comprising, in the same molecule of the compound B, an ethylenically unsaturated bond and a site that inhibits a reaction of the component C with the component A; and
a photopolymerizable initiator, and wherein

the photopolymerizable composition is subjected to the holographic exposure at the first step to form the latent image,

the heat treatment at the second Step causes color development or color extinction of the component A in accordance with the latent image to form the interference fringes, and

the photosensitive and thermosensitive recording layer is irradiated entirely with light at the third step to decolor the photopolymerization initiator so that the interference fringes are fixed.

(7) The hologram recording method as defined in any one of Clauses (4) to (6), wherein the photopolymerization initiator comprises: a spectral sensitizing dye having a maximum absorption wavelength of 300 nm to 1,000 nm: and a compound interacting with the spectral sensitizing dye.

(8) The hologram recording method as defined in Clause (7), wherein the compound interacting with the spectral sensitizing dye comprises an organic borate compound.

(9) The hologram recording method as defined in Clause (7) or (8), wherein the spectral sensitizing dye has a molar absorptivity ε of 1 to 500,000 at a wavelength of the holographic exposure (i.e., a hologram recording wavelength).

(10) The hologram recording method as defined in any one of Clauses (1) to (9), wherein the hologram recording material comprises a plurality of recording layers undergoing color development or color extinction at different hues from one another.

(11) The hologram recording method as defined in any one of Clauses (1) to (10), wherein the hologram recording is effected in a non-rewritable process. That is, the interference fringes are preferably non-rewritable.

(12) A hologram recording material allowing a hologram recording method defined in any one of Clauses (1) to (11).

(13) The hologram recording method as defined in any one of Clauses (1) to (11), wherein multiplexed recording comprising 10 or more recording jobs is effected using a hologram recording method. That is, a multiplexed recording can be performed by subjecting the hologram recording material to the holographic exposure ten times or more.

(14) The hologram recording method, as defined in Clause (13), wherein the multiplexed recording can be effected from beginning to end with the exposure kept constant during any multiplexed recording. That is, the multiplexed recording can be performed under a common exposure amount in each holographic exposure.

(15) An optical recording medium comprising a hologram recording material defined in Clause (12).

(16) An optical recording medium comprising a hologram recording material defined in Clause (12) stored in a light-screening cartridge during storage.

(17) A method for recording on an optical recording medium using a hologram recording method defined in any one of Clauses (1) to (11), (13) and (14).

(18) The method for recording on an optical recording medium as defined in Clause (17), wherein a longer absorption end of the color-developable or color-extinguishable component A defined in Clause (5) or (6) is shorter than a wavelength of the holographic exposure both of before and after the color development or color extinction of the component A.

(19) A 3D display hologram comprising a hologram recording material defined in Clause (12).

(20) A method for recording on a 3D display hologram using a hologram recording method defined in any one of Clauses (1) to (11).

(21) A method for the production of a full-color 3D display hologram using a multi-layer hologram recording method defined in Clause (10)

### BRIEF DESCRIPTION OF THE DRAWING

The features of the invention will appear more fully upon consideration of the exemplary embodiments of the invention, which are schematically set forth in the drawing, in which:

The sole figure is a schematic diagram illustrating the two-flux optical system for hologram. Reference numerals and signs in the figure are set forth below.
10 YAG laser
12 Laser beam
14 Mirror
20 Beam splitter
22 Beam segment
24 Mirror
26 Space filter
28 Sample
30 Hologram recording material
32 He—Ne laser beam
34 He—Ne laser
36 Detector
38 Rotary stage
40 Beam expander

### DETAILED DESCRIPTION OF THE EXEMPLARY EMBODIMENTS

Although the invention will be described below with reference to the exemplary embodiments thereof, the following exemplary embodiments and modifications do not restrict the invention.

According to an exemplary embodiment, it is possible to provide quite a novel hologram recording method and recording material which can satisfy all the requirements for high sensitivity, good storage properties, dryability, multiplexed recording properties (high density recording) and low shrinkage.

A hologram recording method according to one aspect of the invention includes: a first step of forming a latent image in a hologram recording material by holographic exposure (or hologram exposure); a second step of subjecting the hologram recording material having the latent image formed therein to heat treatment so as to form interference fringes providing a refractive index modulation (hereinafter, sometimes referred to as “interference fringes refractive index-modulated”); and a third step of irradiating the hologram recording material entirely with light to fix the interference fringes. The reproduction of a hologram recorded in the hologram recording can be made without erasing recording (i.e. without erasing the refractive index modulation).

The hologram recording method according to one aspect the invention will be further described hereinafter Through the following description, the hologram recording material, too, will be further described.

<Hologram Recording Method>

As previously mentioned, the hologram recording method of the invention comprises a first step of forming a latent image, a second step of forming interference fringes providing a refractive index modulation, a third step of fixing the interference fringes by irradiation with light, and may comprise other steps as necessary. Firstly, the first to third steps will be further described below.

(First Step)

At the first step, a latent image of interference fringes produced by holographic exposure is formed on a hologram recording material described later. In other words, the first step is a holographic exposure step (The first step will be hereinafter occasionally referred to as “holographic exposure step”). In the case where as the hologram recording material there is used, e.g., photopolymerizable composition or material containing same, as previously mentioned, when irradiated with light, the polymerizable compound in the photopolymerizable composition undergoes polymerization reaction mid curing on the irradiated area to form a latent image of interference fringes produced by holographic exposure.

The light source to be used in the aforementioned holographic exposure step is preferably any of ultraviolet ray, visible light and infrared ray having a wavelength of from 200 to 2,000 nm, more preferably ultraviolet ray or visible light having a wavelength of from 300 to 700 nm, even more preferably visible light having a wavelength of from 400 to 700 nm.

The radiation to be used in the hologram recording (exposure) method of the invention is preferably coherent laser beam (having uniform phase and wavelength). As the laser to be used herein there may be used any of solid laser, semiconductor laser, gas laser and liquid laser. Preferred examples of laser beam include YAG laser second harmonic having a wavelength of 532 nm, YAG laser third harmonic having a wavelength of 355 nm, semiconductor laser such as GaN and TnGaN having a wavelength of from about 400 to 415 nm, semiconductor laser such as AlGaInP having a wavelength of from about 650 to 660 nm, Ar ion laser having a wavelength of from 488 nm or 515 nm, He—Ne laser having a wavelength of 632 nm to 633 nm, Kr ion laser having a wavelength of 647 nm, ruby laser having a wavelength of 694 nm, and He—Cd laser having a wavelength of 636 nm, 634 nm, 538 nm, 534 nm and 442 nm.

Further, pulse laser on the order of nanosecond or picosecond is preferably used.

In the case where the hologram recording material of the invention is used as an optical recording medium, YAG laser second harmonic having a wavelength of 532 nm or semiconductor laser such as GaN laser or InGaN laser having a wavelength of from about 400 to 415 nm and AlGaInP laser having a wavelength of from about 650 to 660 nm is preferably used.

The wavelength of the light beam for use in hologram reproduction is preferably the same as or longer than, more preferably the same as that of the light beam for use in holographic exposure (recording).

(Second Step)

At the aforementioned second step, the hologram recording material which has a latent image formed therein at the first step is subjected to heat treatment so that interference fringes refractive index-modulated according to the latent image is formed. In other words, the second step is interference fringes forming step. In the case where the hologram recording material contains a color-developable or color-extinguishable material, the second step is a step at which the color-developable or color-extinguishable material undergoes imagewise color development or color extinction reaction according to the latent image of interference fringes to cause refractive index modulation by which the interference fringes is recorded.

In the case where as the hologram recording material there is used, e.g., a material containing a photopolymerizable composition as well as a color-developable or color-extinguishable component, when heated, the color-developable or color-extinguishable component reacts with a compound which reacts with the color-developable or color-extinguishable component to cause the color-developable or color-extinguishable component to color or decolor, or a specific group in the compound which causes color development or color extinction, whereby color development or color extinction occurs according to the shape of the latent image formed at the first step to form a refractive index-modulated interference fringes. The aforementioned heat treatment is preferably effected in such a manner that the hologram recording material can be entirely treated.

The heating method to be effected during the aforementioned heat treatment can be properly selected from known methods. For example, a heat roller or the like can be used to effect heat treatment. The aforementioned heating temperature is normally preferably from 80° C. to 200° C., more preferably from 85° C. to 130° C. When the heating temperature falls below 80° C., the colored or decolored density can be insufficient. When the heating temperature exceeds 200° C., the hologram recording material can be colored or the support can be damaged. The heating time is preferably from 1 second to 5 minutes, more preferably from 3 seconds to 1 minute. Further, the heat treatment can be preceded by a step of uniformly preheating the entire surface of the hologram recording material at a predetermined temperature less than the color development or color extinction temperature to further enhance the sensitivity of the hologram recording material.

The term “color development reaction” as used herein is meant to indicate a reaction involving the change of absorption spectrum form or preferably either or both of the shift of λmax to longer wavelength and rise of molar absorptivity (ε) in absorption spectrum in the range of ultraviolet ray, visible light and infrared ray having a wavelength of from 200 nm to 2,000 nm. The color development reaction preferably occurs at a wavelength of from 200 nm to 1,000 nm, more preferably from 300 nm to 900 nm.

On the other hand, the term “color extinction reaction” as used herein is meant to indicate generically a reaction by which a color-extinguishable dye having absorption in the range of ultraviolet ray, visible light and infrared ray having a wavelength of from 200 to 2,000 nm undergoes either or both of the shift of λmax to longer wavelength and the reduction of molar absorptivity. The color extinction reaction preferably occurs at a wavelength of from 200 nm to 1,000 nm, more preferably from 300 nm to 900 nm.

The refractive index of the dye rises in the range of from lose to linear absorption maxima wavelength (λmax) to wavelength longer than linear absorption maxima wavelength (λmax), rises drastically in the range of from λmax to wavelength about 200 nm longer than λmax. In this wavelength range, some dyes show a refractive index of more than 1.8, as high as more than 2 in some cases. On the other hand, organic compounds which are not a dye, such as binder polymer, normally have a refractive index of from about 1.4 to 1.6.

It is thus made obvious that the color development or color extinction by holographic exposure makes it possible to fairly make not only a difference in absorbance but also a great difference in refractive index.

The hologram recording material of the invention is preferably a phase type hologram recording material which undergoes refractive index modulation to record interference fringes from the standpoint of enhancement of diffraction efficiency. In other words, it is preferred that the hologram recording material have little or no absorption at the wavelength of reproducing light during hologram reproduction.

It is thus preferred that the color-developable or color-extinguishable component of the invention have no absorption in the hologram recording and reproducing wavelength ranges before and after color development or color extinction, that is, the longer absorption end is shorter than the hologram recording and reproducing wavelength ranges.

The spectral sensitizing dye needs to have absorption in the hologram recording wavelength range during holographic exposure at the first step but preferably decomposes to lose its absorption and sensitizing capacity at the second or third step.

(Third Step)

At the aforementioned third step, the hologram recording material which has been subjected to heat treatment at the second step is entirely irradiated with light so that the refractive index-modulated interference fringes in the hologram recording material is fixed while fixing the color of the spectral sensitizing dye. In other words, the third step is a fixing step of stabilizing the refractive index-modulated interference fringes thus formed.

The entire irradiation of the hologram recording material with light can be accomplished by a method which comprises irradiating tile entire surface of the recording layer with light at a time or a method which comprises gradually irradiating the recording surface with light by scanning until the entire surface of the recording layer is eventually irradiated with light. However, any method can be employed so far as the entire surface of the recording layer of the hologram recording material having a refractive index-modulated interference fringes formed thereon can be irradiated with substantially uniform light. Thus, the entire irradiation at the present step means that the entire surface of the recording material is eventually subjected to uniform irradiation with light rather than holographic exposure and thus is called non-imagewise exposure or solid exposure.

The light source employable at the present step can be properly selected from the group consisting of known light sources having a wavelength of from ultraviolet to infrared range when the recording material comprises a light-absorbing material such as spectral sensitizing dye having absorption in a specific range incorporated therein. In some detail, a light source having a maximum absorption wavelength of from 300 nm to 1,000 nm is preferred. In particular, a laser source emitting blue, green or red beam, LED, flash lamp, fluorescent lamp, xenon lamp, mercury vapor lamp or the like is more desirable. In this case, a light source having a wavelength coincident with the absorption wavelength of the light-absorbing material such as spectral sensitizing dye used is preferably selected properly.

Referring to the irradiation time, it suffices if the hologram recording material is irradiated with light for a period of time long enough to fix the refractive index-modulated interference fringes thus formed and sufficiently extinguish the color derived from the spectral sensitizing dye. However, the irradiation time is preferably from several seconds to scores of minutes, more preferably from several seconds to several minutes.

When the hologram recording material is passed through the present step, the spectral sensitizing dye-derived coloring component left in the hologram recording material can be removed, making it possible to enhance the diffraction efficiency of the hologram recording material. Further, the stability, storage properties, nondestructive reproducibility, etc. of the refractive index-modulated interference fringes, i.e., hologram recording can be enhanced.

Moreover, when as the color-developable component there is used a diazonium salt compound, the diazonium salt compound left in the recording layer having interference fringes formed therein by refractive index modulation can be also deactivated by irradiation with light to inhibit the color development reaction, making it possible to prevent density change, fading or the like and stabilize the storage stability of the hologram recording material.

In the case where as the hologram recording material there is used a material having a multi-layered photosensitive thermosensitive layer having a plurality of monochromatic recording layers having different color-developable or color-extinguishable compounds, the layers being stacked, it is preferred that the respective recording layer be exposed to light having a wavelength coincident with the wavelength to which it is sensitive using a plurality of laser sources at the aforementioned first step. At the present step, too, taking into account the light sensitivity of the various recording layers, these recording layers are independently or simultaneously irradiated with light from all the plurality of light sources to fix the refractive index-modulated interference fringes and extinguish the color.

Such a multi-layered hologram recording material is preferably used for 3D display hologram, particularly for Lipman (reflection) type full-color 3D display hologram which selectively reflects blue, green or red light in this case, recording is preferably effected respectively with the blue, green or red laser. It is also preferred that the hologram recording material has a blue-sensitive layer, a green-sensitive layer and a red-sensitive layer laminated on each other in this order from top. In this arrangement, the blue-sensitive layer preferably contains a UV color-developable or color-extinguishable compound having no absorption with respect to recording blue laser, the green-sensitive layer preferably contains a yellow color-developable or color-extinguishable compound having no absorption with respect to recording green laser, and the red-sensitive layer preferably contains a magenta color-developable or color-extinguishable compound having no absorption with respect to recording red laser.

It is preferred that the hologram recording method of the invention involve no wet process.

The hologram recording method of the invention is preferably not of rewritable type.

The term “not of rewritable type” as used herein is meant to indicate the type which causes irreversible reaction to perform recording. Once recorded, data can be stored without being rewritten even in an attempt to overwrite thereon. Thus, the hologram recording method of the invention is suitable for the storage of important data which are needed to be stored over an extended period of time. It goes without saying that data can be additionally recorded on unrecorded area. In this sense, this type of a recording method is called “write-one-read-many type” recording method.

The refractive index modulation during recording of interference fringes is preferably from 0.00001 to 0.5, more preferably from 0.0001 to 0.3. It is preferred that the more the thickness of the hologram recording material is, the less is the refractive index modulation. It is preferred that the less the thickness of the hologram recording material is, the more is the refractive index modulation.

The (relative) diffraction efficiency η of a hologram recording material is given by the following equation:
η=Idiff/Io (equation 1)
where Io is the intensity of incident light; and Idiff is the intensity of light which is diffracted (transmitted type) or reflected (reflected type). The diffraction efficiency may range from 0% to 100%, preferably 30% or more, more preferably 60% or more, most preferably 80% or more.

The sensitivity of a hologram recording material is normally represented by exposure per unit area (mJ/cm²). The less this value is, the higher is the sensitivity. The exposure at which the sensitivity is defined differs from literature to literature. In some cases, the exposure at which recording (refractive index modulation) begins is defined as sensitivity. In other cases, the exposure at which the maximum diffraction efficiency (refractive index modulation) is given is defined as sensitivity. In further cases, the exposure at which half the maximum diffraction efficiency is given is defined as sensitivity. In still further cases, the exposure at which the gradient of diffraction efficiency relative to exposure E becomes maximum is defined as sensitivity.

According to Kugelnick's theoretical equation, the refractive index modulation Δn at which a certain diffraction efficiency is given is inversely proportional to the thickness d. In other words, the sensitivity at which a certain diffraction efficiency is given differs with thickness. Thus, the more the thickness d is, the less is the required refractive index modulation Δn. Accordingly, the sensitivity cannot be unequivocally compared unless the conditions such as thickness are uniform.

In the invention, sensitivity is defined by “exposure at which half the maximum diffraction efficiency is given (mJ/cm²). The sensitivity of the hologram recording material of the invention is preferably 2 J/cm² or less, more preferably 1 J/cm ² or less, even more preferably 500 mJ/cm² or less, most preferably 200 mJ/cm² or less if the thickness is from about 10 μm to 200 μm.

In the case where the hologram recording material of the invention is used in holographic memory as an optical recording medium, it is preferred that many two-dimensional digital data (referred to as “signal light”) be recorded using a spatial light modulation element (SLM) such as DMD and LCD. Recording is preferably accomplished by multiplexed recording to raise the recording density. Examples of multiplexed recording methods include angular multiplexed, phase multiplexed, wavelength multiplexed and shift multiplexed recording methods. Preferred among these multiplexed recording methods are angular multiplexed recording and shift multiplexed recording. In order to read reproduced two-dimensional data, CCD or CMOS is preferably used.

In the case where the hologram recording material of the invention is used in holographic memory as an optical recording medium, it is essential that multiplexed recording be effected to enhance the capacity (recording density). In this case, multiplexed recording involving preferably 10 or more times, more preferably 50 times or more, most preferably 100 times or more of recording jobs is performed. More preferably, any multiplexed recording can be effected always at a constant exposure to simplify recording system and enhance S/N ratio.

In the case where the hologram recording material of the invention is used as an optical recording medium, the hologram recording material is preferably stored in a light-screening cartridge during storage. It is also preferred that the hologram recording material be provided with a light filter capable of cutting part of wavelength range of ultraviolet ray, visible light and infrared ray other than recording light and reproduced light on the surface or back surface or on the both surfaces thereof.

In the case where the hologram recording material of the invention is used as an optical recording medium, the optical recording medium may be in the form of disc, card or tape or in any other form.

In the case where the hologram recording material of the invention is used as an optical recording medium, the recording layer is preferably a single layer. The recording layer preferably has a thickness of from 0.1 mm to 2 mm.

On the other hand, in the case where the hologram recording material of the invention is used for 3D display hologram, the recording layer may have a single-layer, two-layer or three-layer structure. The recording layer having a single-layer structure is preferably sensitive to blue, green or red light. The recording layer preferably has a thickness of from 1 μm to 100 μm.

A hologram recording material according to one aspect of the invention will be further described hereinafter.

<Hologram Recording Material>

The hologram recording material to be used in the hologram recording method of the invention can be properly selected from the group consisting of materials which can be subjected to holographic exposure to form a latent image in a shape of interference fringes and can be heated to form a refractive index-modulated interference fringes according to the latent image. In particular, a photopolymerizable composition comprising at least an active ray-photopolymerizable compound having at least one ethylenically unsaturated bond and a photopolymerization initiator or a photosensitive thermosensitive hologram recording material having such a photopolymerizable composition is preferred. The aforementioned photopolymerizable composition and photosensitive thermosensitive hologram recording material will be further described hereinafter.

(Photopolymerizable Composition)

The aforementioned photopolymerizable composition comprises at least a compound having at least one ethylenically unsaturated bond which can be polymerized with light (hereinafter occasionally referred to as “photopolymerizable compound”) and a photopolymerization initiator and optionally other components. When the aforementioned photopolymerizable composition is irradiated with light according to the interference fringes formed by holographic exposure at the aforementioned first step, the photopolymerization initiator present in the irradiated area generates radicals by which the aforementioned photopolymerizable compound undergoes polymerization reaction in the composition. As a result, only the irradiated area cures to form a latent image of interference fringes. In the case where the aforementioned photopolymerizable composition contains a color-developable or color-extinguishable component, the color-developable or color-extinguishable component undergoes color development or extinction to cause the aforementioned latent image of interference fringes to be formed on the hologram recording material as a refractive index-modulated interference fringes at the second step. When the hologram recording material is then entirely irradiated with light at the third step, the color of the photopolymerization initiator component left in the hologram recording material is extinguished, making it possible to enhance the storage properties of the refractive index-modulated interference fringes. Further, the extinction of color makes it possible to enhance the diffraction efficiency.

—Photopolymerizable Compound—

The aforementioned photopolymerizable compound is a compound having at least one ethylenically unsaturated bond per molecule which undergoes polymerization reaction to cure when irradiated with light. Examples of the aforementioned photopolymerizable compound include the following photopolymerizable monomers (D1, D2). These photopolymerizable monomers D1 and D2 are preferably used in combination with the compound C free of polymerizable group as described later.

The aforementioned photopolymerizable monomer D1 is preferably a photopolymerizable monomer having at least one vinyl group per molecule. Specific examples of such a photopolymerizable monomer include acrylic acids and salts thereof, acrylic acid esters, acrylamides, methacrylic acids and salts thereof, methacrylic acid esters, methacrylamides, maleic anhydride, maleic acid esters, itaconic acid, itaconic acid esters, styrenes, vinylethers, vinylesters, N-vinyl heterocyclic groups, arylethers, and allylesters.

Preferred among these photopolymerizable monomers are those having a plurality of vinyl groups per molecule. Preferred examples of the photopolymerizable monomers include acrylic acid esters and methacrylic acid esters of polyvalent alcohols such as trimethylolpropane and pentaerythritol, acrylic acid esters and methacrylic acid esters of polyvalent phenols or bisphenols such as resorcinol, pyrogallol and phloroglucinol, acrylate- or methaerylate-terminated epoxy resins, and acrylate- or methacrylate-terminated polyesters.

Particularly preferred among these photopolymerizable monomers are ethylene glycol diacrylate, ethylene glycol dimethacrylate, trimethylol propane triacrylate, pentaerythritol, tetraacrylate, dipentaaerythritol hydroxy pentaacrylate, hexanediol-1,6-dimethacrylate, and diethylene glycol dimethacrylate. The aforementioned photopolymerizable monomer D1 preferably has a molecular weight of from about 100 to 5,000, more preferably from about 300 to 2,000.

Preferred examples of the aforementioned photopolymerizable monomer D2 include styrenesulfonyl aminosalicylic acid, vinylbenzyloxyphthalic acid, zinc β-methacryloxyethoxysaticylate, zinc β-acryloxyethoxysalicylate, vinyloxyeithyloxybenzoic acid, β-methacryloxyethyl orselinate, β-acryloxyethyl orselinate, β-methacryloxy ethoxy phenol, ⊖-acryloxyethoxy phenol, β-methacryloxy ethyl-β-resorcinate, β-acryloxyethyl-β-resorcinate, hydroxystyrenesulfonic acid-N-ethylamide, β-methacryloxypropyl-p-hydroxybenzoate, β-acryloxy propyl-p-hydroxybenzoate, methacryloxymethylphenol, acryloxymethylphenol, methacrylamidepropanesulfonic acid, acrylamidepropanesulfonic acid, β-methacryloxy ethoxy-dihydroxybenzene, β-acryloxyethoxy-dihydroxybenzene, γ-styrenesulfonyloxy-β-methacryloxy propanecarboxylic acid, γ-acryloxypropyl-α-hydroxyethyloxysalicylic acid, β-hydroxyethoxyphenol, β-methacryloxyethyl-p-hydroxy cinnamate, β-acryloxyethyl-p-hydroxy cinnamate, 3,5-distyrenesulfonic acid amidephenol, methacryloxyethoxy phthalic acid, acryloxyethoxyphalic acid, methacrylic acid, acrylic acid, methacryloxyethoxyhydroxynaphtoic acid, acryloxyethoxyhydroxynaphtoic acid,3-β-hydroxy ethoxyphenol, β-methacryloxyethyl-p-hydroxybenzoate, and β-acryloxyethyl-p-hydroxybenzoate,β′-methacryloxyethyl-β-resorcinate, β-methacryloxy ethyloxycarbonylhydroxybenzoic acid, β-acryloxy ethyloxycarbonylhydroxybenzoic acid, N,N′-di-β-methacryloxyethylaminosalicylic acid, N,N′-di-β-acryloxyethylaminosalicylic acid, N,N′-di-β-methacryloxyethylaminosulfonylsalicylic acid, and N,N′-di-β-acryloxyethylaminosulfonylsalicylic acid.

—Photopolymerization Initiator—

When exposed to light, the aforementioned photopolymerization initiator can generate radicals to cause and accelerate a polymerization reaction in the recording layer. This polymerization reaction causes the recording layer to cure, making it possible to form a latent image of interference fringes produced by desired holographic exposure.

The aforementioned photopolymerization initiator can be properly selected from the group consisting of known photopolymerization initiators. In particular, a photopolymerization initiator containing a spectral sensitizing dye having a maximum absorption wavelength of from 300 nm to 1,000 nm and a compound having mutual interaction with the spectral sensitizing dye is preferred. However, in the case where the compound having mutual interaction with the spectral sensitizing dye is a compound having both a dye moiety having a maximum absorption wavelength of from 300 nm to 1,000 nm and a borate moiety, it may act also as the aforementioned spectral sensitizing dye.

Examples of the known photopolymerization initiator include those disclosed in U.S. Pat. No. 4,950,581 (lines 35, column 20—line 35, column 21). Other examples of the known photopolymerization initiator include triazine compounds such as triazine and trihalomethyltriazine (e.g., 2,4-bis(trichloromethyl)-6-4-stylphenyl)-s-triazine) disclosed in EP-A-137452, DE-A-2718254, DO-A-2243621, U.S. Pat. No. 4,950,581 (line 60, column 14—line 44, column 18). In the case where the aforementioned photopolymerization initiator is used in a hybrid system, a cationic photopolymerization initiator may be exemplified in addition to free radical curing agent. Preferred examples of the aforementioned cationic photopolymerization initiator include benzoyl peroxide, peroxide compounds such as peroxide disclosed in U.S. Pat. No. 4,950,581 (lines 17—25, column 19), aromatic sulfonium or iodonium salts disclosed in U.S. Pat. No. 4,950,581 (line 60, column 18—line 10, column 19), and cyclopentadienyl-arene iron (II) complex salts such as (η6-isopropylbenzene)-(η5-cyclopentadienyl)-iron (II) hexafluorophosphate.

Preferred examples of the aforementioned dye/ boron compound include those disclosed in JP-A-62-143044, WP-A-1-138204, JP-T-6-505287, and JP-A-4-261406.

Referring to the aforementioned spectral sensitizing dye having a maximum absorption wavelength of from 300 nm to 1,000 nm, the wavelength to which arbitrary desired dye selected from spectral sensitizing dyes having maximum absorption wavelength in the aforementioned wavelength range is sensitive can be adapted to the light source used to obtain a high sensitivity. As the light source to be used in holographic exposure there may be used one selected from the group consisting of blue, green, red, ultraviolet and infrared lasers. Accordingly, in the case where the aforementioned multi-layer hologram recording material having a plurality of recording layers laminated on each other which undergo color development or color extinction at different hues is used to form a refractive index-modulated interference fringes, spectral sensitizing dyes having different absorption wavelengths can be present in various monochromatic layers having different color development or extinction hues and light sources adapted to the absorption wavelengths can be used. In this arrangement, even a hologram recording material having a plurality of layers laminated on each other can provide a full-color 3D display hologram with a high resolution, a high sensitivity and good storage properties.

The aforementioned spectral sensitizing dye can be properly selected from the group consisting of known compounds. Examples of the spectral sensitizing dye employable herein include those disclosed in patents related to “Bunko zokan shikiso to sougo sayo suru kaboubutsu (Compounds having mutual interaction with spectral sensitizing dye)”, cited later, “Research Disclosure”, vol. 200, December 1980, Item 2003, 6, and Katsumi Tokumaru and Shin Ogawara, “Zokanzai (Sensitizer)”, Kodansha, pp. 160-163, 1987.

Specific examples of these spectral sensitizing dyes include 3-ketocoumarine compounds disclosed in JP-A-58-15603, thiopyrilium salts disclosed in JP-A-58-40302, naphthothiazole melocyanine compounds disclosed in JP-B-59-28328 and JP-B-60-53300, and melocyanine compounds disclosed in JP-B-61-9621, JP-B-62-3842, JP-A-59-89303, and JP-A-60-60104.

Further, dyes disclosed in “Kinosei Shikiso no Kagaku (Chemistry of Functional Dyes)”, CMC, pp. 393-416, 1981, and “Shikizai (Coloring Materials)”, 60[4]212-224 (1987)) may be used. Specific examples of these dyes include cationic methine dyes, cationic carbonium dyes, cationic quinoneimine dyes, cationic indoline dyes, and cationic styryl dyes.

Examples of the aforementioned spectal sensitizing dyes include keto dyes such as coumarine (ketocoumarine or sulfonocoumarine) dye, melostyryl dyes, oxonol dye and hemioxonol dye, non-keto dyes such as non-ketopolymethine dye, triarylmethane dye, xanthene dye, anthracene dye, rhodamine dye, acridine dye, aniline dye and azo dye, non-ketopolymethine dyes such as azomethine dye, cyanine dye, carbocyanine dye, dicarbocyanine dye, tricarbocyanine dye, hemicyanine dye and styryl dye, and quinoneimine dyes such as azine dye, oxazine dye, thiazine dye, quinoline dye and thiazole dye.

The proper use of the aforementioned spectral sensitizing dye makes it possible to predetermine the spectral sensitivity of the photopolymerization initiator used in the hologram recording material to a range of from ultraviolet to infrared. The aforementioned various spectral sensitizing dyes can be used singly or in combination of two or more thereof.

The amount of the aforementioned spectral sensitizing compound to be used is preferably from 0.1% to 10% by mass, more preferably from 0.5% to 5% by mass based on the photopolymerizable monomer in the photopolymerizable composition (mass).

In order to use the hologram recording material particularly for optical recording medium, it is necessary that the hologram recording material be used in the thickness of from 0.1 mm to 1 mm and most of the recording light beams be transmitted by the film. It is thus preferred that the molar absorptivity of the sensitizing dye in the holographic exposure wavelength be lowered to maximize the added amount of the spectral sensitizing dye for the purpose of raising sensitivity.

Also in the case where the hologram recording material is used for 3D display hologram, when the hologram recording material is used in the thickness of from 1 μm to 100 μm, it is necessary that the molar absorptivity and added amount of the spectral sensitizing dye be properly selected is The molar absorptivity (ε) of the sensitizing dye in the holographic exposure wavelength is preferably from not smaller than 1 to not greater than 500,000, more preferably from not smaller than 10 to not greater than 100,000.

In particular, the molar absorptivity (ε) of the sensitizing dye for optical recording medium in the holographic exposure wavelength is more preferably from not smaller than 10 to not greater than 10,000, most preferably from not smaller than 10 to not greater than 5,000.

The transmittance of the hologram recording material with respect to recording wavelength light is preferably from 10% to 99%, more preferably from 20% to 95%, even more preferably from 30% to 90%, most preferably from 40% to 85% from the standpoint of diffraction efficiency, sensitivity and recording density (multiplexity). Accordingly, the molar absorptivity of the sensitizing dye in the recording wavelength and the added molarity of the sensitizing dye are preferably adjusted according to the thickness of the hologram recording material to this end.

λmax of the sensitizing dye is preferably shorter than the hologram recording wavelength, more preferably between the same wavelength as the hologram recording wavelength and the wavelength of 100 nm shorter than the hologram recording wavelength.

In particular, in the case where the hologram recording material is used for optical recording medium, the molar absorptivity of the sensitizing dye in the recording wavelength is preferably not greater than one fifth, more one tenth, even more preferably one twentieth, one fiftieth of the molar absorptivity at λmax.

As the compound having mutual interaction with the aforementioned spectral sensitizing dye there may be used one or more compounds selected from the group consisting of known compounds which can begin to undergo photopolymerization reaction with the aforementioned photopolymerizable monomer (D1, D2). The presence of this compound with the aforementioned spectral sensitizing dye allows the spectral sensitizing dye to be drastically sensitive to light in the spectral absorption wavelength range and generate radicals efficiently, making it possible to enhance the sensitivity of the hologram recording material and inhibit the generation of radicals using arbitrary light source having a wavelength of from ultraviolet to infrared. Examples of the compound having mutual interaction with the aforementioned spectral sensitizing dye include organic borate compounds and the following compounds.

Aromatic ketones such as benzophenone, 4,4-bis(dimethylamino)benzophenone, 4-methoxy-4′-dimethyl aminobenzophenone, 4,4′-dimethoxybenzopbonone, 4-dimethylaminobenzophenone, 4-dimethylamino acetophenone, benzylanthraquinone, 2-tert-butyl anthraquinone, 2-methylathraquinone, xanthone, thioxanthone, 2-chlorothioxanthone, 2,4-diethyl thioxanthone, fluorenone, acridone and bisacylphosphinc oxide (e.g., bis(2,4,6-trimcthylbenzoyl)-phenyl phosphine oxide produced by Ciba Specialty Chemicals Co., Ltd.); benzoin and benzoinethers such as benzoin methyl ether, benzoin ethyl ether, benzoin isopropyl ether and benzoin phenyl ether; 2,4,6-triarylimidazle dimers such as 2-(o-chlorophenyl)-4,5-dipbenylimidazole dimer, 2-o-chlorophenyl)-4,5-di(m-methoxyphenyl)imidazole dimer, 2-(o-fluorophenyl)-4,5-diphenylimidazole dimer, 2-(o-methoxyphenyl)-4,5-diphenylimidazole dimer and 2-(o-methoxyophenyl)-4,5-diphenylimidazole dimer; polyhalogen compounds such as carbon tetrabromide, phenyl tribromomethylsulfone and phenyltrichloro methyl ketone; compounds disclosed in JP-A-59-133428, JP-B-57-1819, JP-B-57-6096 and U.S. Pat. No. 3,615,455; S-triazine derivatives having trihalogen-substituted methyl group disclosed in JP-A-58-29803 such as 2,4,6-tis(trichloromethyl)-S-triazine, 2-methoxy-4,6-bis(trichloromethyl)-S-triazine, 2-amino-4,6-bis(trichloromethyl)-S-triazine and 2-(P-methoxystyryl)-4,6-bis(trichloromethyl)-S-triazine; organic peroxides disclosed in JP-A-59-189340 such as methyl ethyl ketone peroxide, cyclohexanone peroxide, 3,3,5-trimethylcyclohexanone peroxide, benzoyl peroxide, ditertiary butyl diperoxide isophthalate, 2, 5-dimethyl-2,5-di(benzoylperoxy)hexane, tertiary butyl peroxy benzoate, a,a′-bis(tertiary-butyl peroxy isopropyl)benzene, dicumyl peroxide and 3,3′,4,4′-tetra-(tertiary butylperoxycarbonyl)benzophenone; adinium salt compounds disclosed in U.S. Pat. No. 4,743,530; organic boron compounds disclosed in EP 0223587 such as tetramethyl ammonium salt of triphenyl butyl borate, tetrabutyl ammonium salt of triphenyl butyl borate and tetramethyl ammonium salt of tri(P-methoxyphenyl) butyl borate; and other diaryl iodonium salts and iron arene complexes.

Combinations of two or more compounds having mutual interaction with spectral sensitizing dye have been known. These compounds may be used in the invention. Examples of the combinations of two or more compounds having mutual interaction with spectral sensitizing dye include combination of 2,4,5-triarylimidazole dimer and mercaptobenzoxazole, combination of 4,4′-bis(dimethyl amino)benzophenone and benzoin methyl ether disclosed in U.S. Pat. No. 3,427,161, combination of benzoyl-N-methylnaphthothiazoline and 2,4-bis(trichloromethyl)-6-(4′-methoxyphenyl)triazole disclosed in U.S. Pat. No. 4,239,850, combination of dialkylaminobenzoic acid ester and dimethylthioxanthone disclosed in JP-A-57-23602, and combination of three compounds, i.e., 4,4′-bis(dimethylamino)benzophenone, benzophenone and polylialogenated methyl disclosed in JP-A-59-78339.

Among them, the combination of 4,4′-bis(dimethylamino)benzophenone and benzophenone, the combination of 2,4-diethylthioxanthone and ethyl 4-dimethylaminobenzoate or the combination of 4,4′-bis(dimethylamino)benzophenone and 2,4,5-triarylimidazole dimmer is preferred.

Preferred among the aforementioned “compounds having mutual interaction with spectral sensitizing dye” are organic borate compounds, benzoin ethers, S-triazine derivative having trihalogen-substituted methyl group, organic peroxides and adinium salt compounds. More desirable among these compounds are organic borate compounds. The use of the “compound having mutual interaction with spectral sensitizing dye” in combination with the aforementioned spectral sensitizing dye makes it possible to generate radicals locally and effectively on the exposed area and attain higher sensitivity.

Examples of the aforementioned organic borate compound include organic borate compounds (hereinafter occasionally referred to as “borate compound I”) disclosed in JP-A-62-143044, JP-A-9-188685, JP-A-9-188686 and JP-A-9-188710, and spectral sensitizing dye-based borate compounds obtained from cationic dye (hereinafter occasionally referred to as “borate compound II”). Specific examples of the aforementioned borate compound I will be given below, but the invention is not limited thereto.

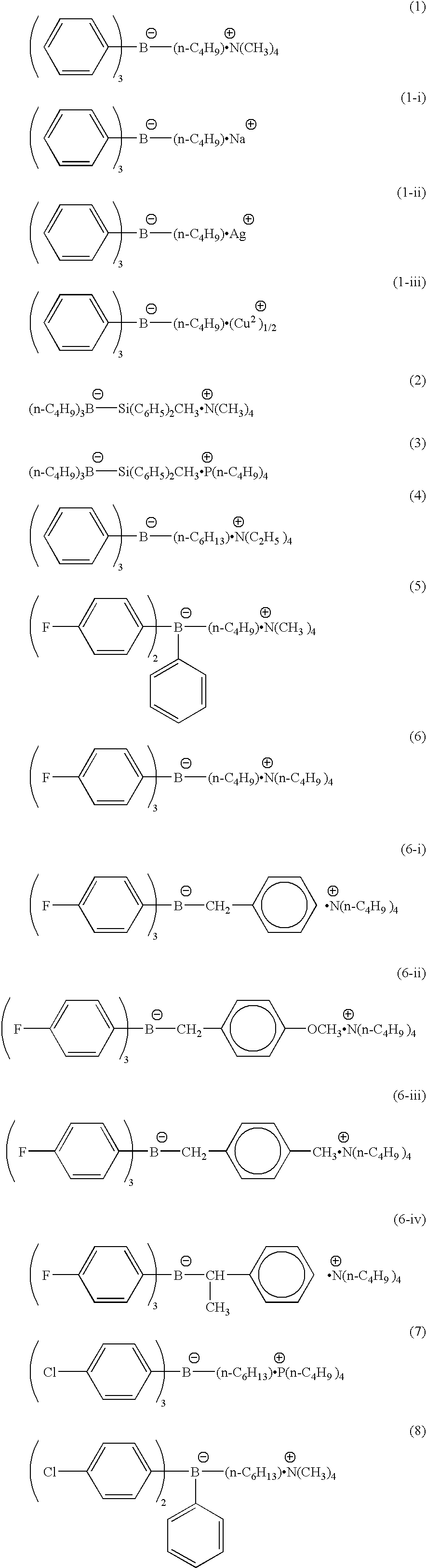

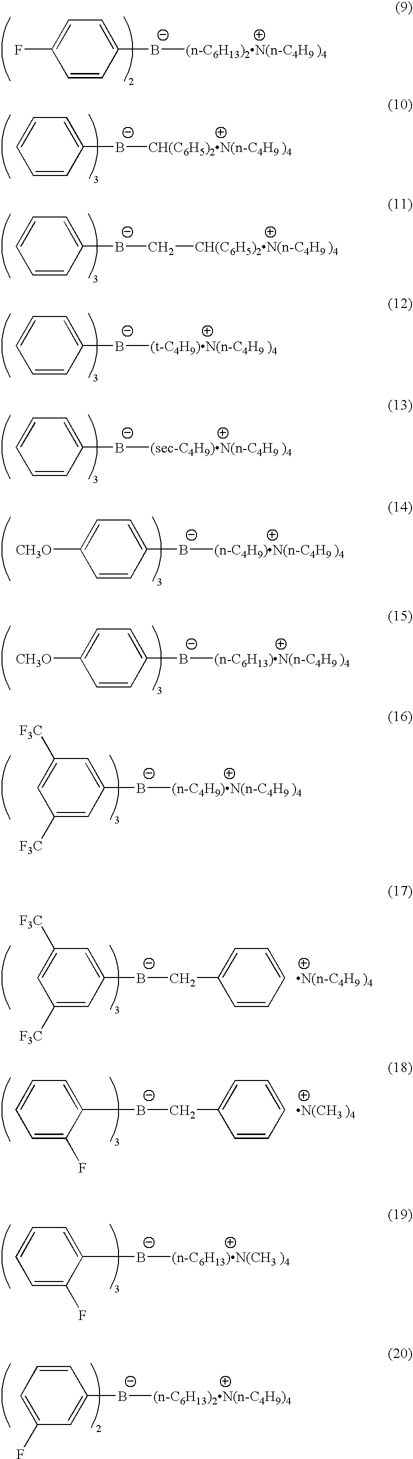

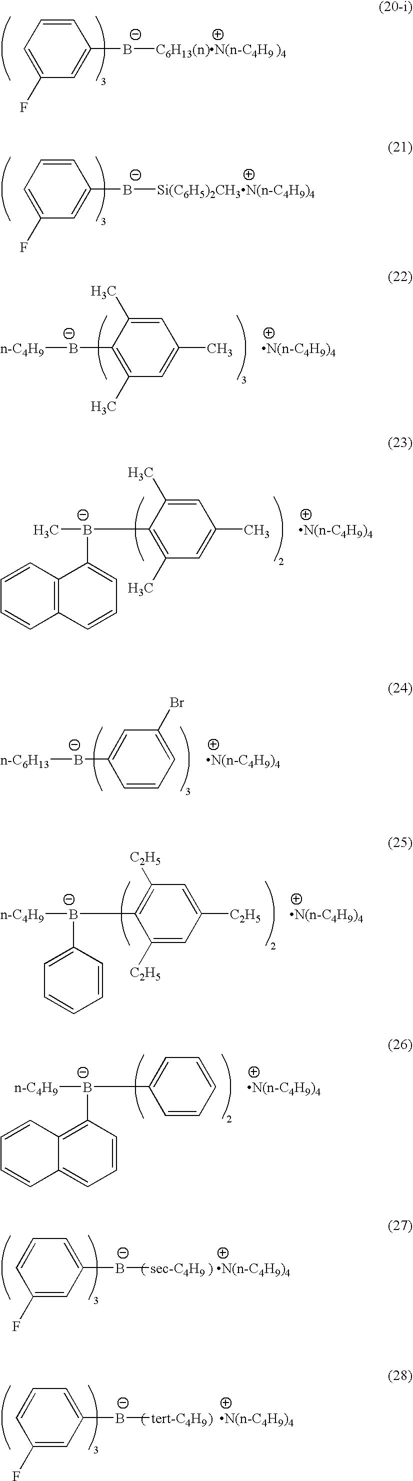

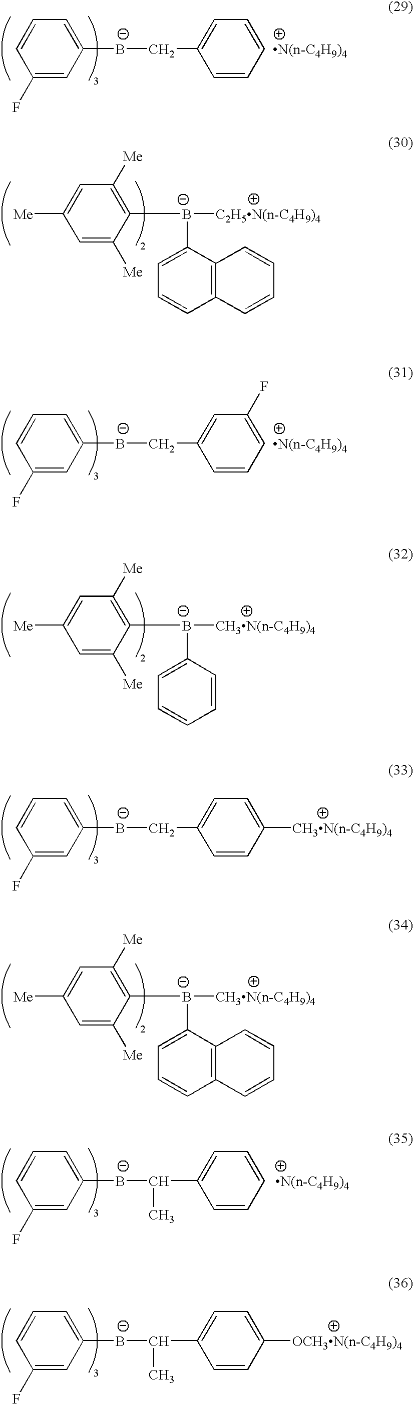

Further examples of the aforementioned borate compound I include spectral sensitizing dye-based organic borate compounds (borate compound II) which can be obtained from cationic dyes disclosed in the above cited “Kinosei Shikiso no Kagaku (Chemistry of Functional Dyes)”, CMC, pp. 393-416, 1981, and “Shikizai (Coloring Materials)”, 60[4]212-224 (1987)). This borate compound II is a compound having a dye moiety and a borate moiety in combination. This borate compound II has three functions, that is, effective absorption of light source energy by the light absorbing capacity of the dye moiety, acceleration of polymerization reaction by the radical-releasing capacity of the borate moiety and extinction of the color of the spectral sensitizing dye present therewith.

In some detail, any cationic dye having a maximum wavelength range of 300 nm or more, preferably from 300 nm to 1,100 nm, more preferably from 300 nm to 800 nm can be used to advantage. Preferred among these cationic dyes are cationic methine dyes, polymethine dyes, triarylmethane dyes, indoline dyes, azine dyes, xanthene dyes, thioxanthone dyes, cyanine dyes, hemicyanine dyes, rhodamine dyes, azamethine dyes, oxazine dyes, phenothiazine dyes, acridine dyes, pyrilium dyes, and styryl dyes. More desirable among these cationic dyes are cationic cyanine dyes, hemicyanine dyes, rhodamine dyes and azamethine dyes.

Further examples of these cationic dyes include squarilium cyanine dyes, melocyanine dyes, oxonol dyes, styryl dyes, benzylidene dyes, cinnamylidene dyes, coumarine dyes, ketocoumarine dyes, styrylcoumarine dyes, pyrane dyes and styryl dyes which are neutral or anionic themselves but become a cationic dye when they have a cationic group. Preferred among these dyes are melocyaninc dyes, oxonol dyes, benzylidene dyes and styryl dyes having cationic group.

The borate compound II obtained from the aforementioned organic cationic dye can be obtained from an organic cationic dye and an organic boron anion according to the method disclosed in European Patent Application Disclosure No. 223,587(A1).

Specific examples of the borate compound IT obtained from cationic dye will be given below, but the invention is limited thereto.

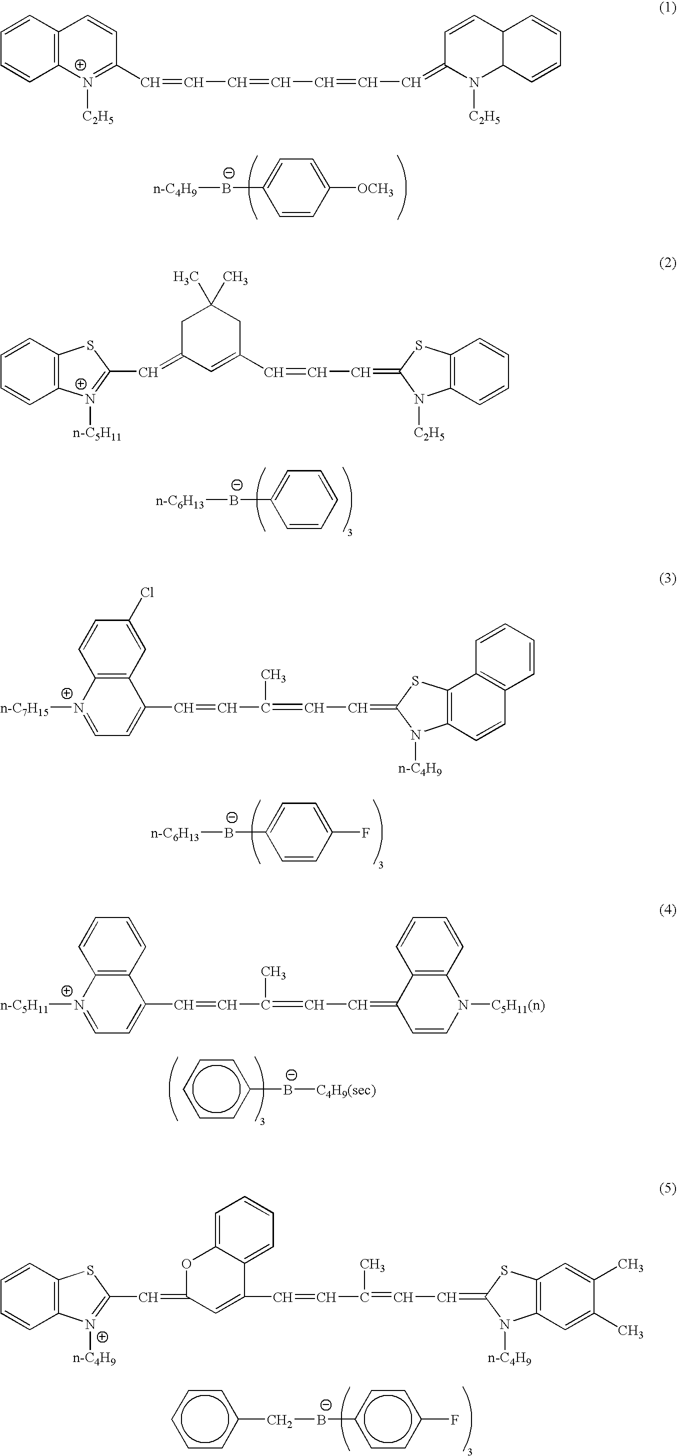

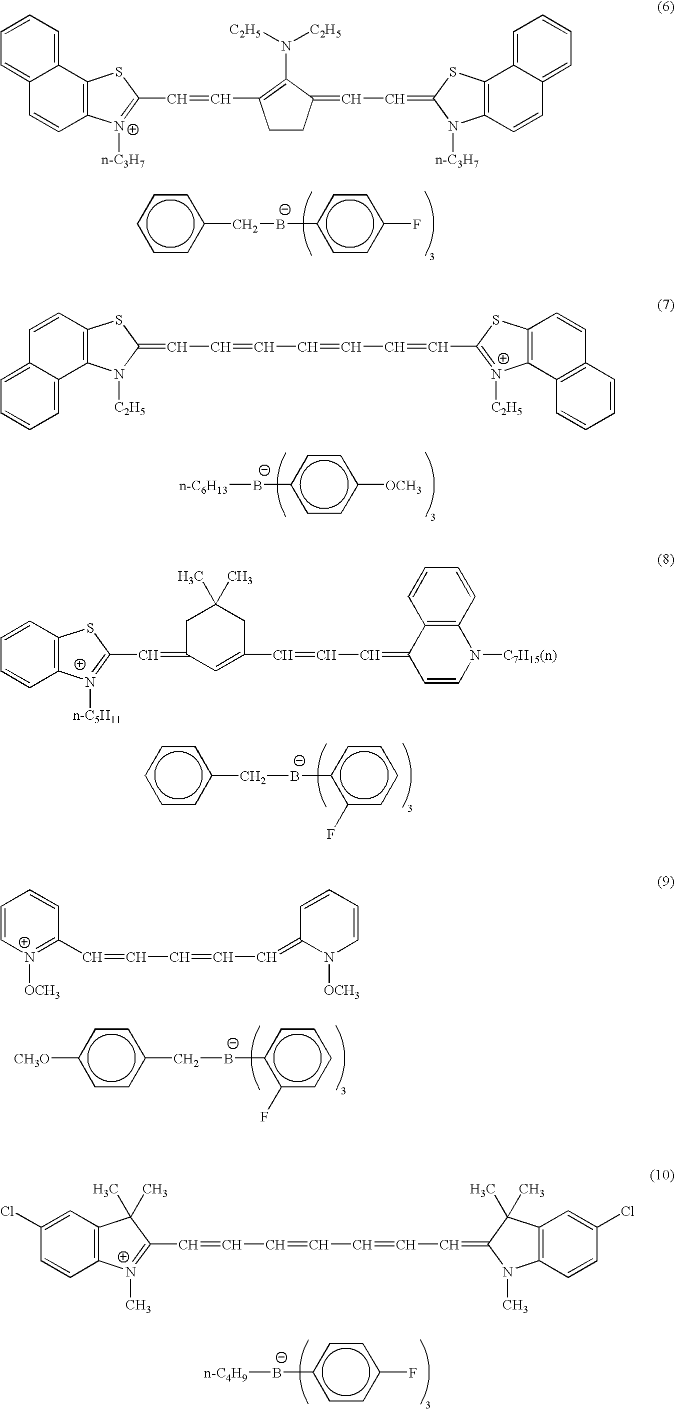

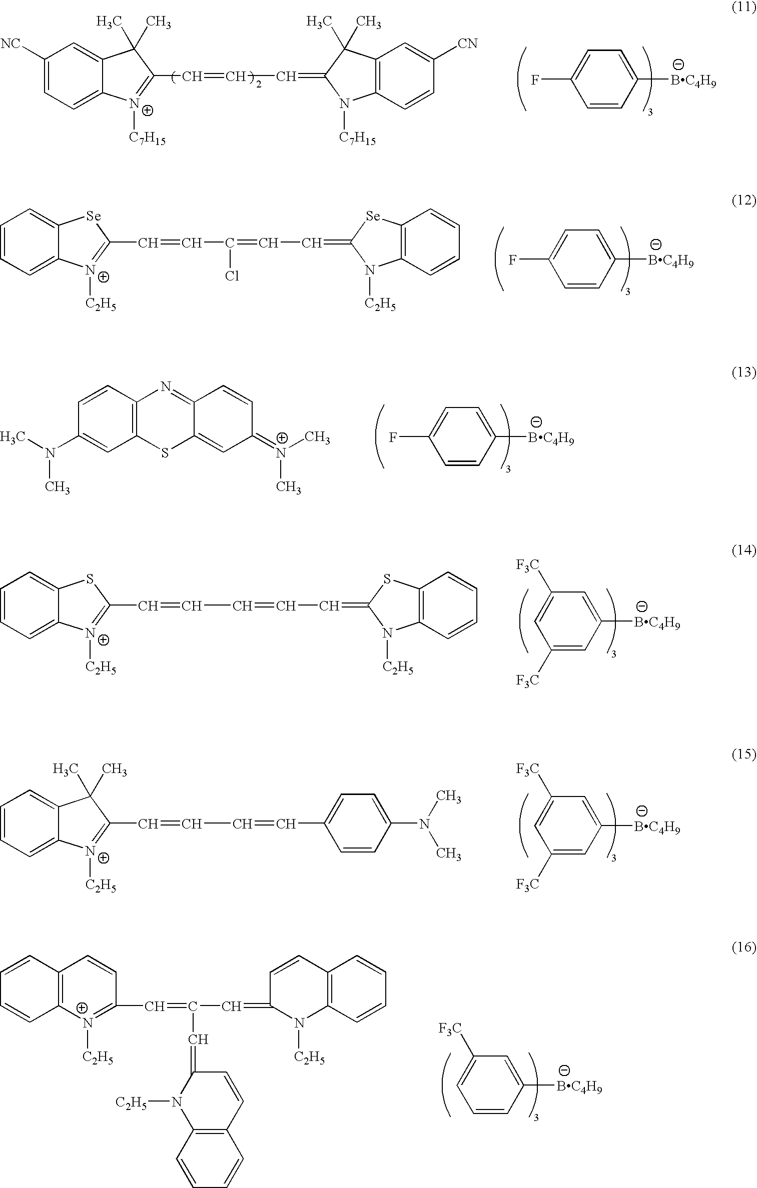

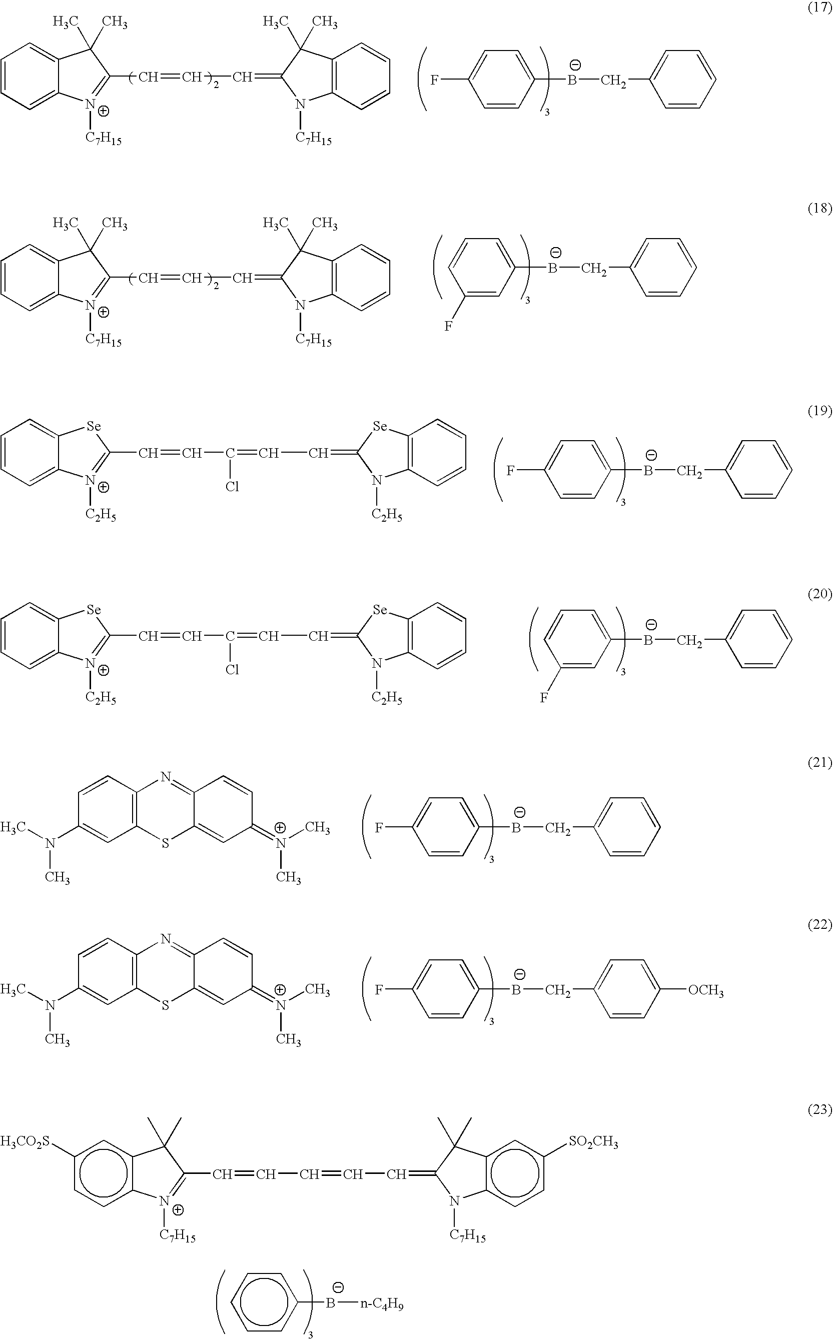

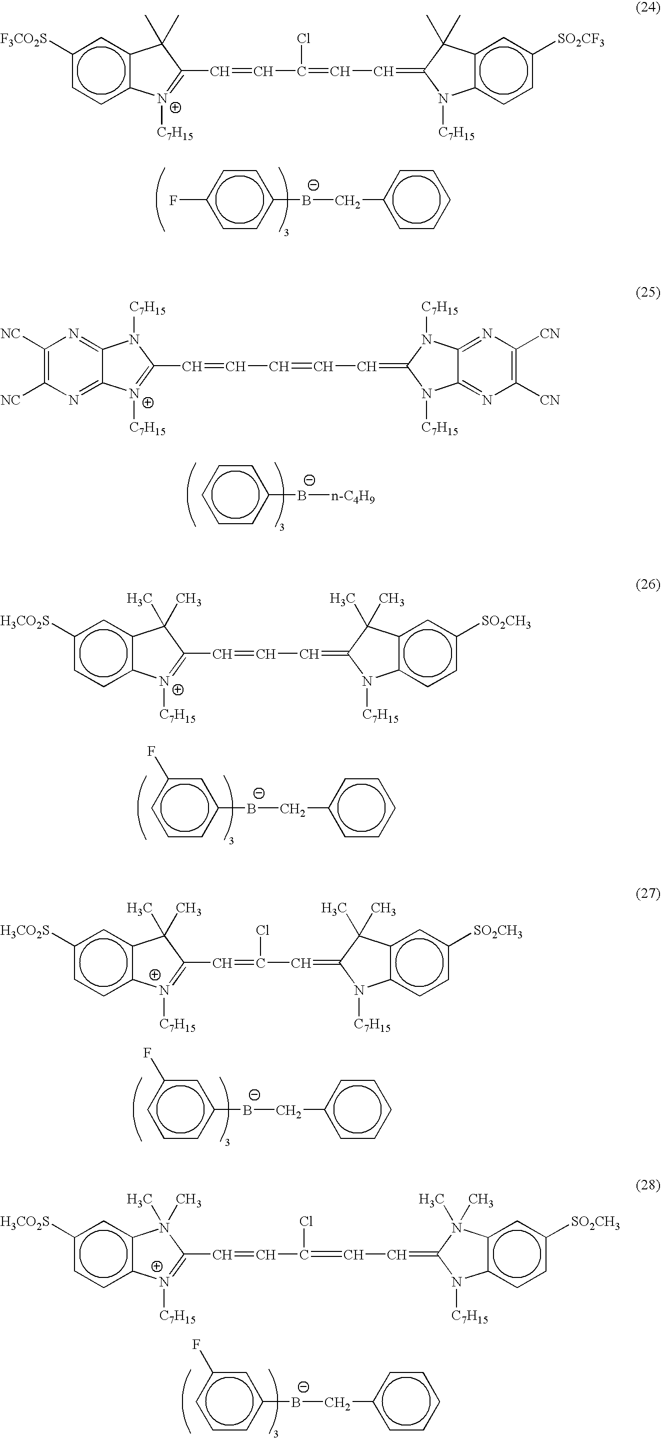

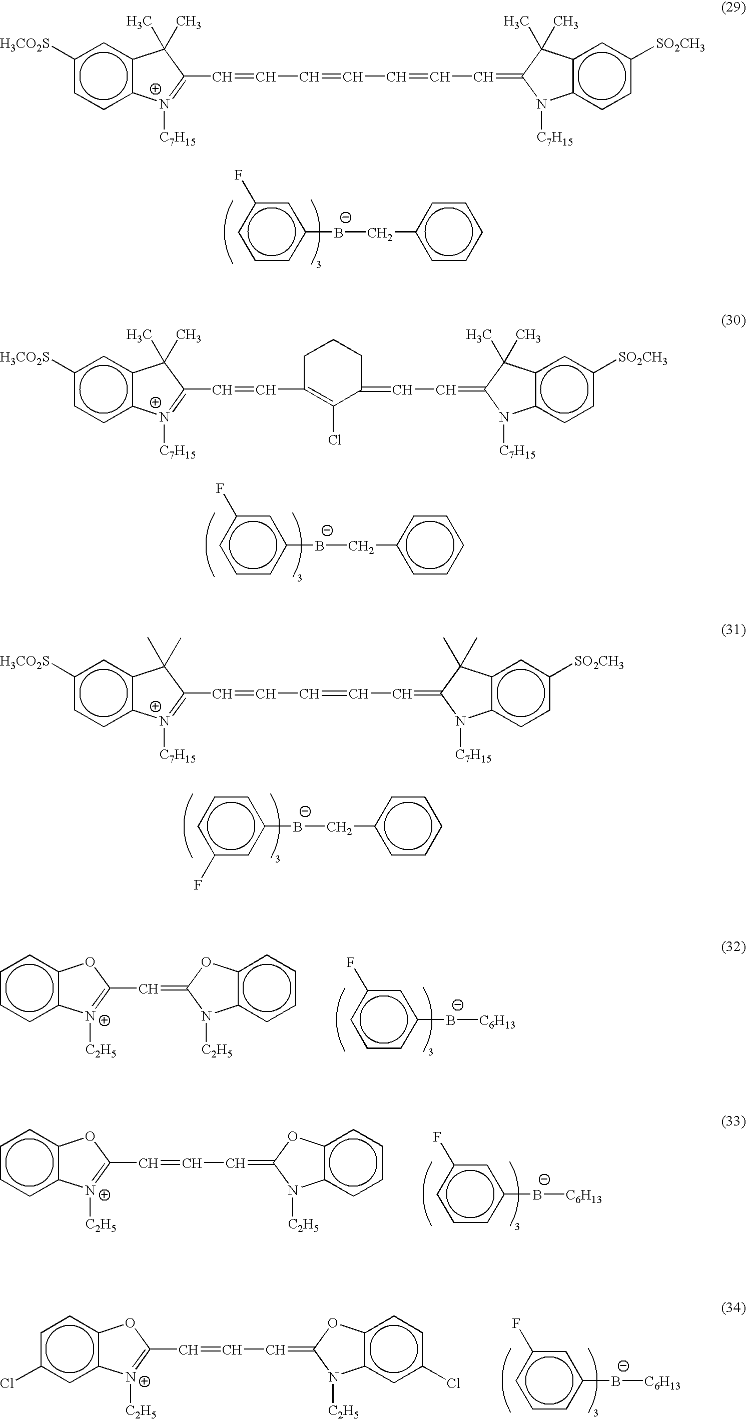

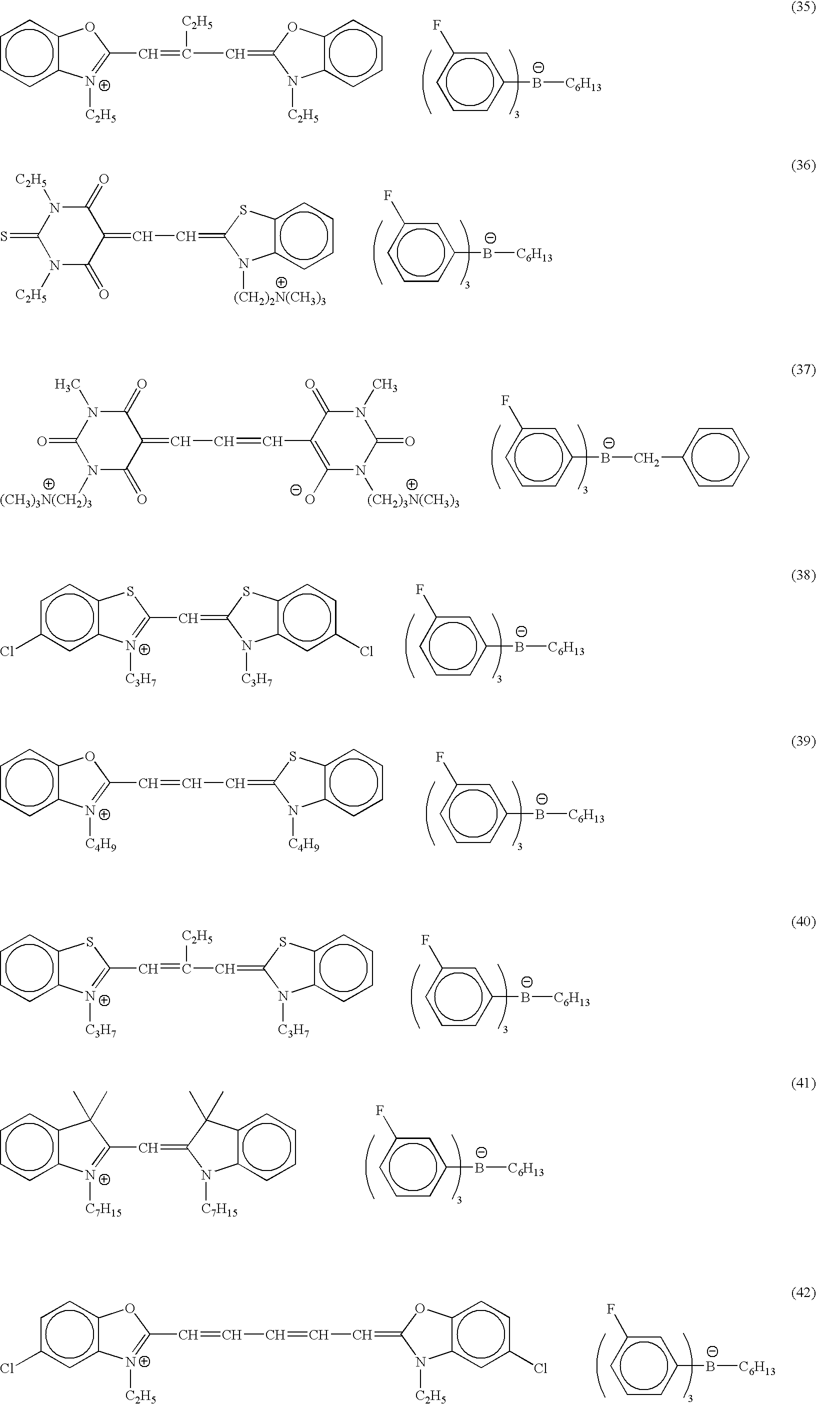

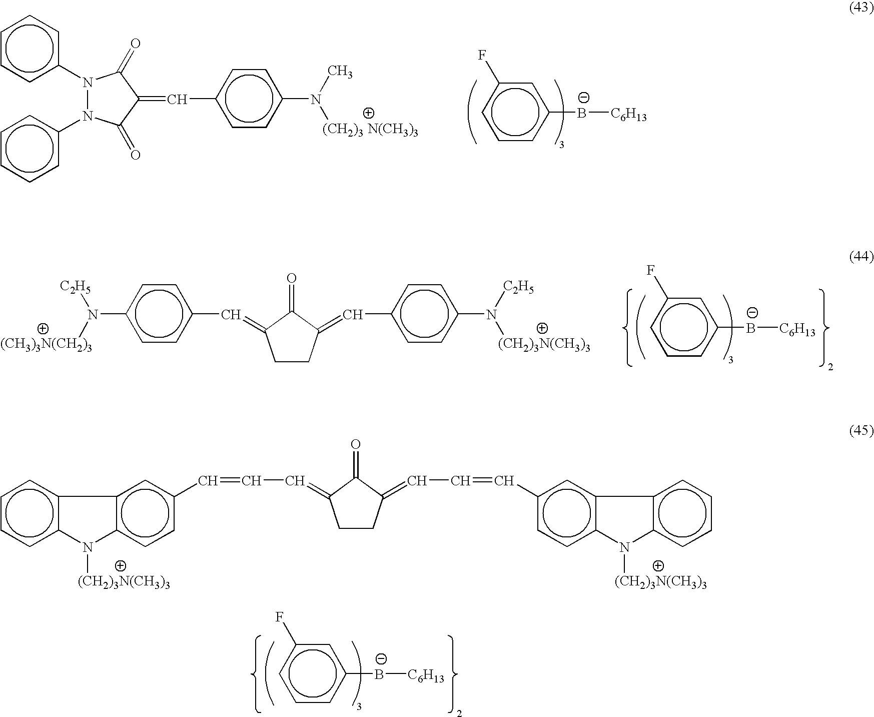

The aforementioned borate compound II is a multi-functional compound as mentioned above. The aforementioned photopolymerization initiator is preferably formed by a spectral sensitizing dye and a compound having mutual interaction with the spectral sensitizing dye in proper, combination from the standpoint of provision of high sensitivity and sufficient color-extinguishability. In this case, the photopolymerization initiator is more preferably a photopolymerization initiator (1) having the aforementioned spectral sensitizing dye and borate compound I in combination or a photopolymerization initiator (2) having the aforementioned borate compound I and borate compound II in combination.

In this case, the mixing ratio of the spectral sensitizing dye and the organic borate compound in the photopolymerization initiator is very important for the enhancement of high sensitivity and the provision of sufficient color-extinguishability by irradiation at the fixing step. In the case of the aforementioned photopolymerization initiator (1), it is particularly preferred from the standpoint of provision of sufficiently high sensitivity and color-extinguishability that the photopolymerization initiator comprise the borate compound I incorporated therein in an amount required to sufficiently extinguish the color of the spectral sensitizing dye left in the layer in addition to the spectral sensitizing dye/borate compound I required for photopolymerization reaction in a molar ratio of 1/1. In other words, the mixing molar ratio of spectral sensitizing dye/borate compound I is preferably from 1/1 to 1/50, more preferably from 1/1.2 to 1/30, most preferably from 1/1.2 to 1/20. When the mixing molar ratio falls below 1/1, sufficient polymerization reactivity and color-extinguishability cannot be obtained. When the mixing molar ratio exceeds 1/50, the resulting coating solution exhibits deteriorated spreadability to disadvantage.

In the case of the aforementioned polymerization initiator (2), it is particularly preferred from the standpoint of provision of sufficiently high sensitivity and color-extinguishability that the borate compound I and the borate compound II be used in combination such that the amount of the borate site is not smaller than equimolecular to the dye site. The mixing ratio of borate compound I/borate compound U is preferably from 1/1 to 50/1, more preferably 1.2/1 to 30/1, most preferably from 1.2/1 to 20/1. When the mixing ratio of borate compound I/borate compound I falls below 1/1, radicals are little generated, making it impossible to obtain sufficient polymerization reactivity and color-extinguishability. When the mixing ratio of borate compound I/borate compound II exceeds 50/1, sufficient sensitivity cannot be obtained to disadvantage.

The sum of the amount of the spectral sensitizing dye and the organic borate compound in the photopolymerization initiator is preferably from 0.1 to 10% by mass, more preferably from 0.1 to 5% by mass, most preferably from 0.1 to 1% by mass based on the amount of the compound having a polymeri7able group. When the sum of the amount of the spectral sensitizing dye and the organic borate compound falls below 0.1% by mass, thc effect of the invention cannot be obtained. When the sum of the amount of the spectral sensitizing dye and the organic borate compound exceeds 10% by mass, the resulting coating solution exhibits deteriorated storage properties as well as deteriorated spreadability.

—Other Components—

The aforementioned photopolymerizable composition may comprise the following components incorporated therein as necessary. In other words, as auxiliaries there may be added an oxygen scavenger or a reducing agent such as active hydrogen donor chain transfer agent for the purpose of accelerating polymerization reaction or other compounds for accelerating polymerization in chain transferring manner. Examples of the aforementioned oxygen scavenger include phosphine, phosphonate, phosphite, primary silver salt, and other compounds which can be easily oxidized by oxygen. Specific examples of these oxygen scavengers include N-phenyl glycine, trimethylharbituric acid, N,N-dimethyl-2,6-diiisopropylaniline, and N,N,N-2,4,6-pentamethyl anilic acid. Examples of useful polymerization accelerators include thiols, thioketones, trihalomethyl compounds, lophine dimer compounds, iodonium salts, sulfonium salts, adinium salts, organic peroxides, and azides.

(Photosensitive Thermosensitive Hologram Recording Material)

The aforementioned photosensitive thermosensitive hologram recording material is not specifically limited in its structure so far as it comprises the already described photopolymerizable composition incorporated therein For example, the aforementioned photosensitive thermosensitive hologram recording material may have a properly selected structure such as hologram recording material having a recording layer containing a photopolymerizable composition provided on a support depending on the purpose In particular, as the basic structure there is preferably used a photosensitive thermosensitive hologram recording material arranged as described in the following clauses (a) or (b).
(a) A photosensitive thermosensitive hologram recording material having on a support a photosensitive thermosensitive recording layer containing a photopolymerizable composition comprising a color-developable or color-extinguishable component A contained in a thermo-responsive microcapsule and at least a substantially colorless compound B and a photopolymerization initiator provided on the exterior of the thermo-responsive microcapsule, which compound B has a polymerizable group having at ]cast one ethylenically unsaturated bond and a site which reacts with the color-developable or color-extinguishable component A to cause color development or color extinction in the same molecule; and
(b) A photosensitive thermosensitive hologram recording material having on a support a photosensitive thermosensitive recording layer containing a photopolymerizable composition comprising a thermo-responsive microcapsule containing a color-developable or color-extinguishable component A and at least a substantially colorless compound C, a substantially colorless compound D and a photopolymerization initiator provided on the exterior of the thermo-responsive microcapsule, which compound C reacts with the color-developable or color-extinguishable component A to cause color development or color extinction, which compound D has a polymerizable group having at least one ethylenically unsaturated bond and a site which reacts with the color-developable or color-extinguishable component A to cause color development or color extinction in the same molecule.

In the aforementioned photosensitive thermosensitive hologram recording material (a), the photopolymerizable composition provided on the exterior of the microcapsule undergoes polymerization reaction with radicals generated from the photopolymerization initiator to cure according to interference fringes formed by holographic exposure. Thus, a desired latent image is formed. Subsequently, when the photosensitive thermosensitive hologram recording material is heated, the aforementioned compound B present in the dark area of interference fringes then moves through interior of the hologram recording material where it reacts with the color-developable or color-extinguishable component A in the capsule to cause color development or color extinction. Accordingly, color development or color extinction doesn't occur in the bright area of interference fringes. The portion in the dark of interference fringes which has not been cured undergoes color development or color extinction. In this manner, this type of a photosensitive thermosensitive hologram recording material forms a refractive index-modulated interference fringes.

Specific examples of this embodiment include a hologram recording material comprising a positive-working photosensitive thermosensitive hologram recording material having a photosensitive thermosensitive hologram recording layer comprising a compound containing an electron-accepting group and a polymerizable group in the same molecule and a photosetting composition containing a photopolymerization initiator provided on the exterior of a microcapsule and an electron-donating colorless dye contained in the microcapsule as disclosed in JP-A-3-87827. In this case, at the aforementioned first step, the hologram recording material is subjected to holographic exposure so that the photosetting composition present on the exterior of the microcapsule is polymerized and cured to form a latent image according to interference fringes. Subsequently, at the second step, the hologram recording material is heated to cause the compound containing an electron-accepting group and a polymerizable group in the same molecule present in the dark area of the interference fringes to move through the interior of the hologram recording material where it reacts with the electron-donating colorless dye in the microcapsule to cause color development or color extinction. Thus, recording is made in the form of refractive index-modulated interference fringes. Further, at the third step, the hologram recording material is irradiated with light from the light source used at the first step to fix the refractive index-modulated interference fringes and extinguish the remaining photopolymerization initiator component. Accordingly, the area of latent image corresponding to the bright area of the interference fringes in holographic exposure undergoes neither color development nor color extinction. Only the area corresponding to the dark area of interference fringes which has not been cured undergoes color development or color extinction, making it possible to form a high contrast sharp refractive index-modulated interference fringes, i.e., hologram recording.

When the aforementioned photosensitive thermosensitive hologram recording material (b) is subjected to holographic exposure according to interference fringes, the aforementioned compound D having a polymerizable group undergoes polymerization with radicals generated from the photopolymerization initiator which has reacted upon exposure to cure the film. Thus, a desired latent image is formed. The aforementioned compound C moves depending on the properties of the latent image (cured area) to react with the color-developable or color-extinguishable component A in the capsule. Thus, a refractive index-modulated interference fringes is formed. Accordingly, this type of a photosensitive thermosensitive hologram recording material undergoes color development or color extinction in the bright area of interference fringes to form a refractive index-modulated interference fringes.

Specific examples of this embodiment of a hologram recording material include a hologram recording material comprising a negative-working photosensitive thermosensitive recording material having a photosensitive thermosensitive recording layer comprising an electron-accepting compound, a polymerizable vinyl monomer and a photopolymerization initiator provided on the exterior of a microcapsule and an electron-donating colorless dye contained in the microcapsule as disclosed in JP-A-4-211252.

The mechanism of formation of interference fringes by refractive index modulation is not definitely known but can be presumed as follows. In some detail, when the hologram recording material is subjected to holographic exposure at the first step, the vinyl monomer present on the exterior of the microcapsule undergoes polymerization while the electron-accepting compound present in the bright area of interference fringes is not caught by the polymer thus formed but shows a lowered mutual interaction with the vinyl monomer and thus is present in the form of a mobile compound having a high diffusion speed. On the other hand, the electron-accepting compound in the dark area of interference fringes is present trapped by the vinyl monomer present therewith. Accordingly, when the hologram recording material is heated at the second step, the electron-accepting compound present in the dark area of interference fringes preferentially moves through the interior of the hologram recording material where it reacts with the electron-donating colorless dye in the microcapsule to cause color development or color extinction by which a refractive index-modulated interference fringes is formed. The electron-accepting compound in the dark area of interference fringes cannot permeate through the capsule wall even when heated. Accordingly, the electron-accepting compound doesn't react with the electron-donating colorless dye and thus doesn't make contribution to color development or color extinction. Subsequently, when the hologram recording material is entirely irradiated with light at the third step, the refractive index-modulate interference fringes formed by color development or color extinction is fixed while the color of the remaining photopolymerization initiator is extinguished. Accordingly, this type of a photosensitive thermosensitive hologram recording material allows the formation of a refractive index-modulated interference fringes with color development or color extinction at the bright area of interference fringes but without color development or color extinction at the dark area of interference fringes, making it possible to form a high contrast sharp refractive index-modulated interference fringes.

Further, a photosensitive thermosensitive hologram recording material comprising a photosensitive thermosensitive recording layer formed by a plurality of recording layers provided on a support may be provided. In order to provide such a photosensitive thermosensitive hologram recording material, color-developable or color-extinguishable components A which develop or extinguish different hues may be contained in respective microcapsules. A plurality of monochromatic recording layers each containing various color microcapsules are laminated on each other. Thus, a hologram recording material can be realized which can reproduce multiple colors when subjected to holographic exposure using a plurality of laser sources having different wavelengths.

The various constituents of the photosensitive thermosensitive hologram recording material will be further described hereinafter. The photosensitive light-sensitive hologram recording material comprises as color-developable or color-extinguishable sources a color-developable or color-extinguishable component A contained in a microcapsule and a substantially colorless compound (aforementioned compound B or C; hereinafter occasionally referred to as “compound causing color development or extinction”) incorporated therein, which substantially colorless compound reacting with the color-developable or extinguishable component A to cause the color development or extinction thereof.

Description will begin with the case where the hologram recording material of the invention employs color development reaction.

Preferred examples of combination of the two components (color-developable component A and compound causing color development) as the coloring source include the following combinations (a) to (r) (In the following examples, the former indicates a color-developable component and the latter indicates a compound causing color development.)
(a) Combination of electron-donating dye precursor and electron-accepting compound;
(b) Combination of diazonium salt compound and coupling component (hereinafter occasionally referred to as “coupler compound”);
(c) Combination of organic acid metal salt such as silver behenate and silver stearate and reducing agent such as protocatechinic acid, spiroindane and hydroquinone;
(d) Combination of long-chain aliphatic acid iron salt such as ferric stearate and ferric myristate and phenol such as tannic acid, gallic acid and ammonium salicylate;
(e) Combination of salt of organic acid such as acetic acid, stearic acid and palmitic acid with heavy metal such as nickel, cobalt, lead, copper, iron, mercury and silver and sulfide of alkaline metal or alkaline earth metal such as calcium sulfide, strontium and potassium sulfide or combination of the aforementioned organic acid heavy metal salt and organic chelating agent such as s-diphenyl carbazide and diphenyl carbazone;
(f) Combination of heavy metal sulfate such as sulfate of silver, lead, mercury and sodium and sulfur compound such as sodium tetrathionate, sodium thiosulfate and thiourea;
(g) Combination of aliphatic acid ferric salt such as ferric stearate and aromatic polyhydroxy compound such as 3,4-hydroxytetraphenylmethane;
(h) Combination of organic acid metal salt such as silver oxalate and mercury oxalate and organic polyhydroxy compound such as polyhydroxy alcohol, glycerin and glycol;
(i) Combination of aliphatic acid ferric salt such as ferric peralgonate and ferric laurate and thiocetyl carbamide or isothiocetyl carbamide derivative;
(j) Combination of organic acid lead salt and thiourea derivative such as ethylene thiourea and N-dodecyl thiourea;
(k) Combination of higher aliphatic acid heavy metal salt such as ferric stearate and copper stearate and zinc dialkyldithiocarbaminate;
(l) Oxazine dye-forming combination such as combination of resorcin and nitroso compound;
(m) Combination of formazane compound and reducing agent and/or metal salt;
(n) Combination of protected dye (or leuco dye) precursor and deprotecting agent;
(o) Combination of oxidation type coloring agent and oxidizing agent;
(p) Combination of phthalonitrile mid diiminoisoindoline (combination causing the production of phthalocyanine);
(q) Combination of isocyanate and diiminoisoindoline (combination causing the production of colored pigment); and
(r) Combination of pigment precursor and acid or base (combination causing the formation of pigment)

Among the aforementioned color-developable components A, the color-developable component contained in a microcapsule is preferably a substantially colorless electron-donating dye precursor (hereinafter referred to as “electron-donating colorless dye”) or diazonium salt compound.

As the aforementioned electron-donating colorless dye there may be used one which has been heretofore known. Any compound which can react with the aforementioned compound B or C to undergo color development or extinction can be used. Specific examples of these electron-donating colorless dyes will be given below, but the electron-donating colorless dye employable herein is not limited thereto. Specific examples of these electron-donating colorless dyes include various compounds such as phthalide-based compounds, fluorane-based compounds, thiazine-based compounds, indolyl phthalide compounds, leucoauramine-based compounds, rhodamine lactam-based compounds, triphenylmethane-based compounds, triazene-based compounds, spiropyrane-based compounds, pyrazine-based compounds, fluorene-based compounds and cyanine-based compounds (leucocyanine compound).

Examples of the phthalide-based compounds employable herein include compounds disclosed in U.S. Reissued Pat. No. 23,024, U.S. Pat. Nos. 3,491,111, 3,491,112, 3,491,116 and 3,509,174. Specific examples of these compounds include 3,3-bis(p-dimethylaminophenyl)-6-dimethylaminophthalide, 3,3-bis(p-diethylamino-o-butoxyphenyl)-4-azaphthalide, 3-(p-diethylamino-o-butoxyphenyl)-3-(1-pentyl-2-methylindole-3-il)-4-azaphthalide, and 3-(p-dipropylamino-o-methylphenyl)-3-(1-octyl-2-methylindole-3-il)-5-aza(or -6-aza, or -7-aza)phthalide.

Examples of the fluorane-based compounds employable herein include compounds disclosed in U.S. Pat. Nos. 3,624,107, 3,627,787, 3,641,011, 3,462,828, 3,681,390, 3,920,510 and 3,959,571. Specific examples of these compounds include 2-(dibenzylamino)fluorane, 2-anilino-3-methyl-6-diethylaminofluorane, 2anilino-3-methyl-6-dibutylaminofluorane, 2-anilino-3-methyl-6-N-ethyl-N-isoamylaminofluorane, 2-anilino-3-methyl-6 N-methyl-N-cyclohexylaminofluorane, 2-anilino-3-chloro-6-diethylaminofluorane, 2-anilino-3-methyl-6-N-ethyl-N-isobutylaminofluorane, 2-anilino-6-dibutylamino fluroane, 2-anilino-3-methyl-6-N-ethyl-N-tetrahydro furfurylaminofluorane, 2-anilino-3-methyl-6-piperidinoaminofluorane, 2-(o-chloroanilino)-6-diethylaminofluorane, and 2-(3,4-dichloroanilino)-6-diethylaminofluorane.

Examples of the thiazine-based compounds employable herein include benzoylleucomethylene blue, and p-nitrobenzylleucomethylene blue. Examples of the leucoauramine-based compounds employable herein include 4,4′-bis-dimethylaminobenzhydrin benzyl ether, N-halophenyl-leucoauramine, and N-2,4,5-trichlorophenyl leucoauramine.

Examples of the rhodaminelactam-based compounds employable herein include rhodamine-B-anilinolactam, and rhodamine-(p-nitrilo)lactam. Examples of the spiropyrane-based compounds include compounds disclosed in U.S. Pat. No. 3,971,808. Specific examples of these compounds include 3-methyl-spiro-dinaphthopyrane, 3-ethyl-spiro-dinaphthopyrane-3,3′-dichloro-spiro-dinaphthopyrane, 3-benylspiro-dinaphthopyrane; 3-methyl-naphtho-(3-methoxy-benzo)spriopyrane, and 3-propyl-spiro-dibenzopyrane.

Examples of the pyridine-based compounds and pyrazine-based compounds include compounds disclosed in U.S. Pat. Nos. 3,775,424, 3,853,869 and 4,246,318. Examples of the fluorene-based compounds include compounds disclosed in JP-A-63-094878 (Japanese Patent Application No. 61-240989).

Specific preferred examples of the aforementioned electron-donating colorless dyes include the following compounds, but the invention is not limited thereto.

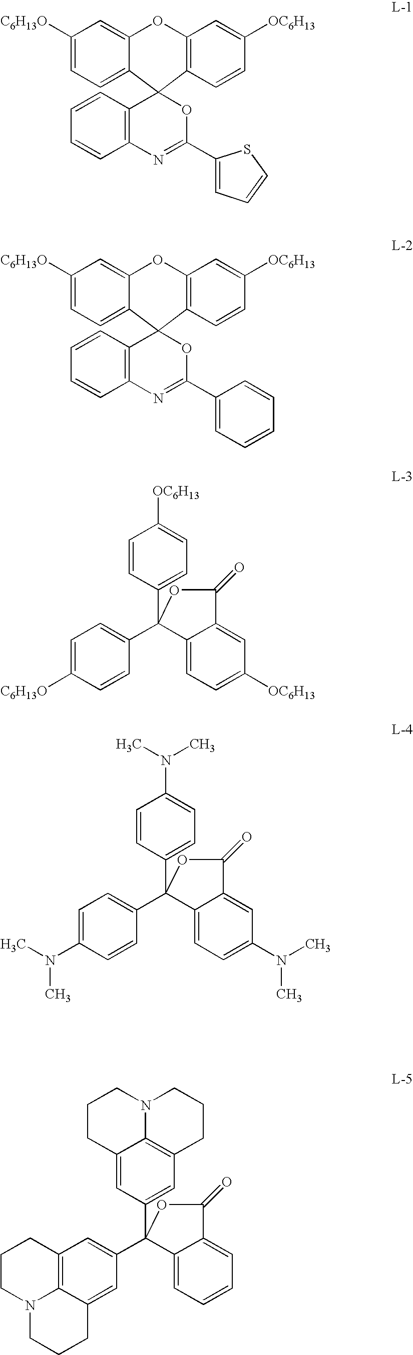

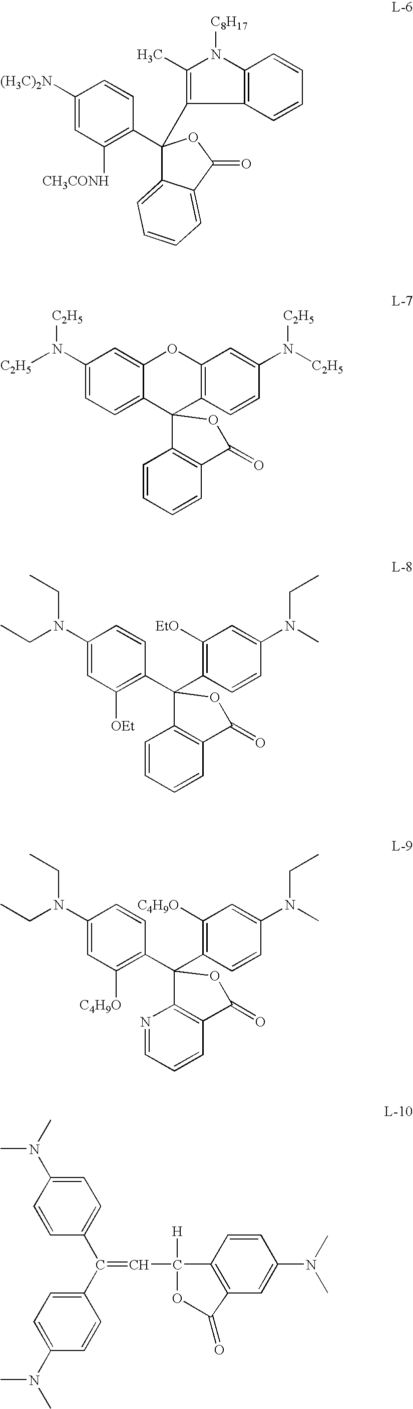

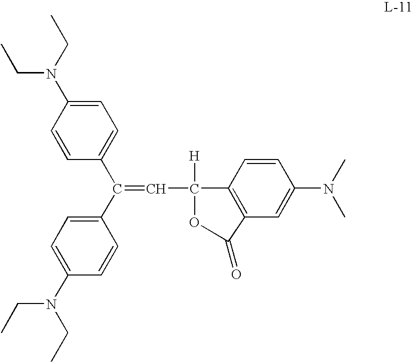

The cyanine-based compound (leucocyaine compound) is a compound which, when provided with an acid (proton), becomes a cyanine dye to develop color (shift to longer wavelength). This compound, too, is used as an electron-donating dye to advantage. The cyanine base preferably develops a color in the range of visible light or ultraviolet rays.

Preferred examples of the cyanine base will be gives below, but the invention is not limited thereto.

| 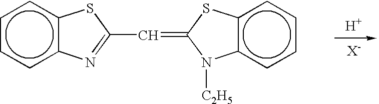 | 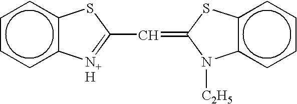 | |
|---|---|---|
| Cyanine base | | |
| (Leucocyanine dye), colorless | Cyanine dye (yellow) | |
| 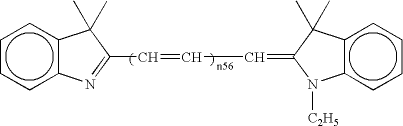 | LC-1 LC-2 LC-3 | n₅₆0 1 2 |
| 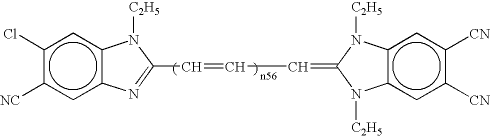 | LC-4 LC-5 LC-6 | n₅₆0 1 2 |
| 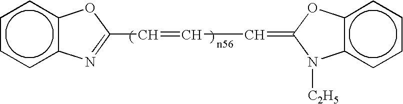 | LC-7 LC-8 | n₅₆0 1 |
| 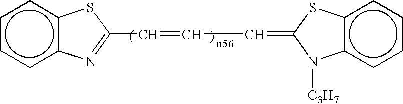 | LC-9 LC-10 | n₅₆0 1 |

| | |
|---|---|
| 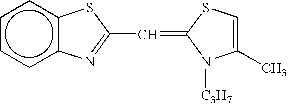 | 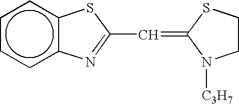 |
| LC-11 | LC-12 |
| 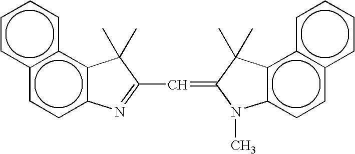 | 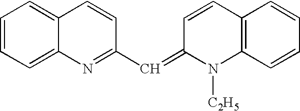 |
| LC-13 | LC-14 |

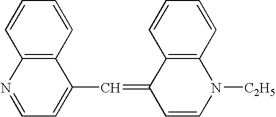

LC-15

In the case where the aforementioned multi-layered recording material is used as a full-color 3D hologram recording material, it is preferred that the red-sensitive layer be composed of an electron-donating colorless dye for magenta-developable dye and the green-sensitive layer be composed of an electron-donating colorless dye for yellow-developable dye. As the magenta-developable dye and yellow-developable dye there may be used various dyes disclosed in U.S. Pat. Nos. 4,800,149 and 4,800,148. On the other hand, the blue-sensitive layer is preferably composed of a UV color-developable dye. Preferred examples of the UV color-developable dye include the aforementioned cyanine bases and azo dyes made of diazo compound described later.

The amount of the aforementioned electron-donating colorless dye to be used is preferably from 0.01 to 3 g/m², more preferably from 0.1 to 1 g/m². When the amount of the aforementioned electron-donating colorless dye to be used falls below 0.01 g/m², sufficient color density cannot be occasionally obtained. When the amount of the aforementioned electron-donating colorless dye to be used exceeds 3 g/m², the resulting coating solution can exhibit a deteriorated spreadability. The multi-layered recording layer, if used, is formed by laminating a plurality of recording layers comprising an electron-donating colorless dye incorporated therein in the above defined amount.

As the aforementioned diazonium salt compound there may be used a compound represented by the following general formula:
Ar—N₂⁺X—
wherein Ar represents an aromatic ring group; and X— represents an acid anion.

The diazonium salt compound is a compound which, when heated, undergoes coupling reaction with a coupler to develop color or, when irradiated with light, to decompose. The diazonium salt compound can be controlled in its maximum absorption wavelength by the position or kind of substituents on Ar moiety.

In the aforementioned general formula, Ar represents a substituted or unsubstituted aryl group. Examples of the substituent on Ar include alkyl groups, alkoxy groups, alkylthio groups, aryl groups, aryloxy groups, arylthio groups, acyl groups, alkoxycarbonyl groups, carbamoyl groups, carbamide groups, sulfonyl groups, sulfamoyl groups, sulfonamide groups, ureido groups, halogen groups, amino groups, heterocyclic groups, nitro groups, and cyano groups. These substituents may be further substituted.

The aryl group represented by Ar is preferably a C6-C30 aryl group. Examples of the C6-C30 aryl group include phenyl groups, 2-methylphenyl groups, 2-chlorophenyl groups, 2-methoxyphenyl groups, 2-butoxyphenyl groups, 2-(2-ethylhexyloxy)phenyl groups, 2-octyloxyphenyl groups, 3-(2,4-di-t-pentylphenoxy ethoxy)phenyl groups, 4-chlorophenyl groups, 2,5dichlorophenyl groups, 2,4,6-trimethylphenyl groups, 3-chlorophenyl groups, 3-methylphenyl groups, 3-methoxyphenyl groups, 3-butoxyphenyl groups, 3-cyanophenyl groups, 3-(2-ethylhexyloxy)phenyl groups, 3,4-dichlorophenyl groups, 3,5-dichlorophenyl groups, 3,4-dimethoxyphenyl groups, 3-(dibutylaminocarbonylmethoxy)phenyl groups, 4-cyanophenyl groups, 4-methylphenyl groups, 4-methoxy phenyl groups, 4-butoxyphenyl groups, 4(2-ethylhexyloxy)phenyl groups, 4-benzoylphenyl groups, 4-aminosulfonylphenyl groups, 4-N, N-dibutylaminosulfonylphenyl groups, 4-ethoxycarbonyl phenyl groups, 4-(2-ethylhexylcarbonyl)phenyl groups, 4-fluorophenyl groups, 3-acetylphenyl groups, 2-acetylaminophenyl groups, 4-(4-chlorophenylthio)phenyl groups, 4-(4-methylphenyl)thio-2,5-butoxy phenyl groups, and 4-(N-benzyl-N-methylamino)-2-dodecyloxycarbonylphenyl groups.

These aryl groups may be further substituted by alkyloxy group, alkylthio group, substituted phenyl group, cyano group, substituted amino group, halogen atom, heterocyclic group or the like.

The maximum absorption wavelength %max of the diazonium salt compound to be used in the invention is preferably 450 nm or less, more preferably from 290 nm to 440 nm from the standpoint of effectiveness. The diazonium salt compound to be used in the invention is preferably a diazonium salt compound having 12 or more carbon atoms, a water solubility of 1% or less and an ethyl acetate solubility of 5% or more.

Specific preferred examples of the diazonium salt compound will be given below, but the invention is not limited thereto.

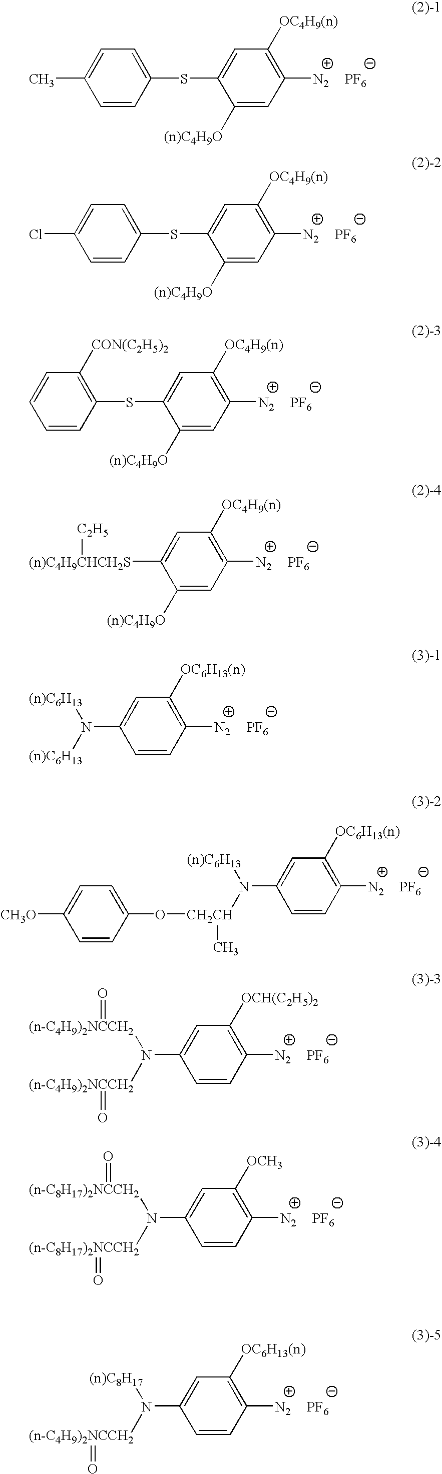

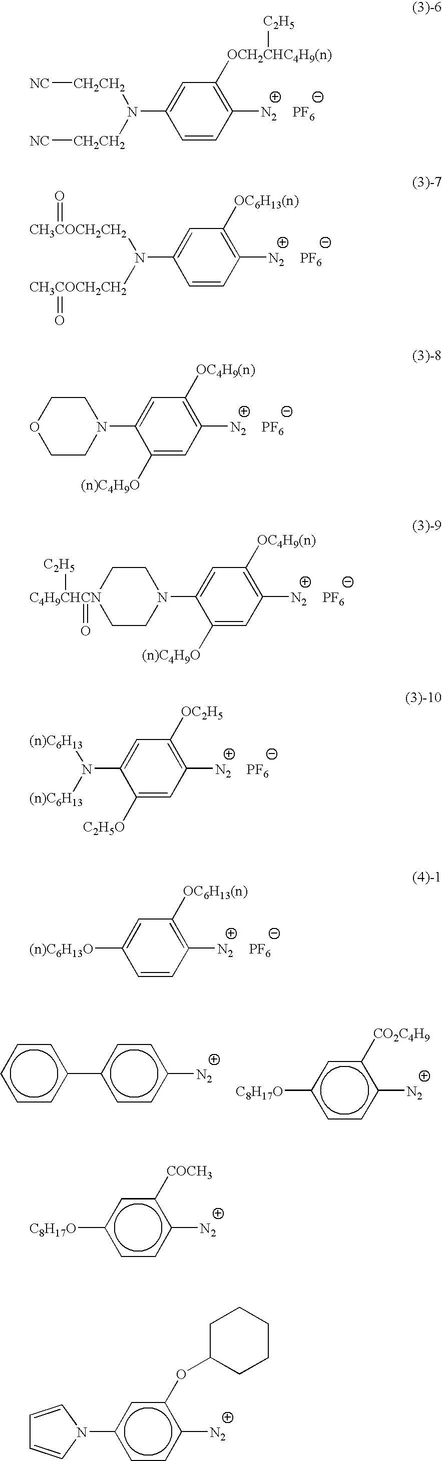

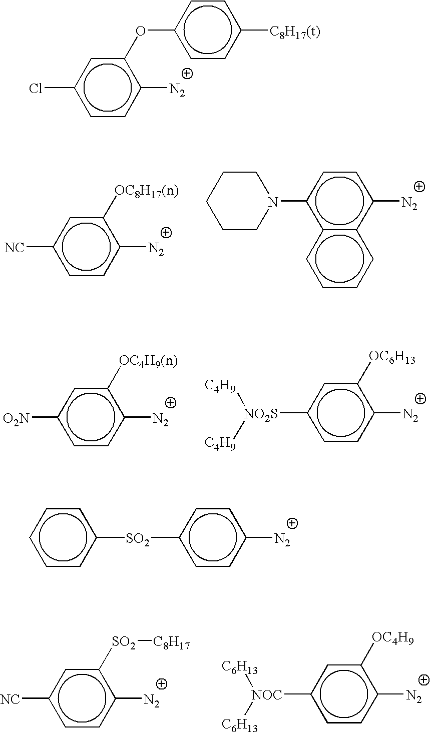

The aforementioned diazonium salt compounds may be used singly or in combination of two or more thereof depending on various purposes such as adjustment of hue.

The amount of the aforementioned diazonium salt compound to be incorporated in the photosensitive thermosensitive recording layer is preferably from 0.01 to 3 g/m², more preferably from 0.02 to 1.0 g/m². When the amount of the aforementioned diazonium salt compound to be incorporated in the photosensitive thermosensitive recording layer falls below 0.01 g/m², sufficient color developability cannot be occasionally obtained. When the amount of the aforementioned diazonium salt compound to be incorporated in the photosensitive thermosensitive recording layer exceeds 3 g/m², the resulting photosensitive thermosensitive recording layer exhibits a deteriorated sensitivity or occasionally needs to be fixed for a longer period of time. The multi-layered recording layer, if used, is formed by laminating a plurality of recording layers having an electron-donating colorless dye incorporated therein in the above defined amount.

The case where the hologram recording material of the invention is subject to color extinction reaction will be described hereinafter.

The combination of two components as such color-extinguishable components (color-extinguishable component A and compound causing color extinction) may be obtained by changing the color development reaction in the aforementioned combinations (a) to (r) to color extinction reaction. Particularly preferred among these or other combinations are the following combinations (In the following examples, the former indicates the color-extinguishable component and the latter indicates the compound causing color extinction.)
(s) Combination of oxidation type color-extinguishing agent and oxidizing agent;
(t) Combination of dissociation product of dissociative dye (acid color-extinguishable dye) and electron-donating compound (acid);
(u) Combination of electron-donating dye precursor color-developable material and electron-donating compound (base); and
(v) Combination of radical color-extinguishable dye and radical generator

Particularly preferred among these combinations is (t) combination of dissociation product of dissociative dye (acid color-extinguishable dye) and electron-donating compound (acid). Preferred examples of dissociation product of dissociative dye (acid color-extinguishable dye) include dissociation product of dissociative benzylidne dye, dissociative oxonol dye, dissociative xanthene dye and dissociative azo dye. More desirable among these dissociation products of dissociative dye are dissociation product of dissociative benzylidne dye, dissociative oxonol dye and dissociative azo dye. The term “dissociative dye” as used herein is meant to indicate generically a dye having an active hydrogen having pKa of from about 2 to 14 such as —OH, —SH, —COOH, —NHSO2R and —CONHSO2R which shows absorption in a longer wavelength range or shift to higher e when it releases proton. Accordingly, by treating a dissociative dye with a base so that it is dissociative, a dye which shows absorption in a longer wavelength range or shift to higher ε can be prepared. When a photo-acid is generated, such a dissociative dye can be rendered non-dissociative so that it undergoes color extinction (absorption in a shorter wavelength range or shift to lower ε).

Specific examples of the dissociation product of dissociative dye (acid color-extinguishable dye) of the invention will be given below, but the invention is not limited thereto.
<Dissociation Product of Dissociative Dye>

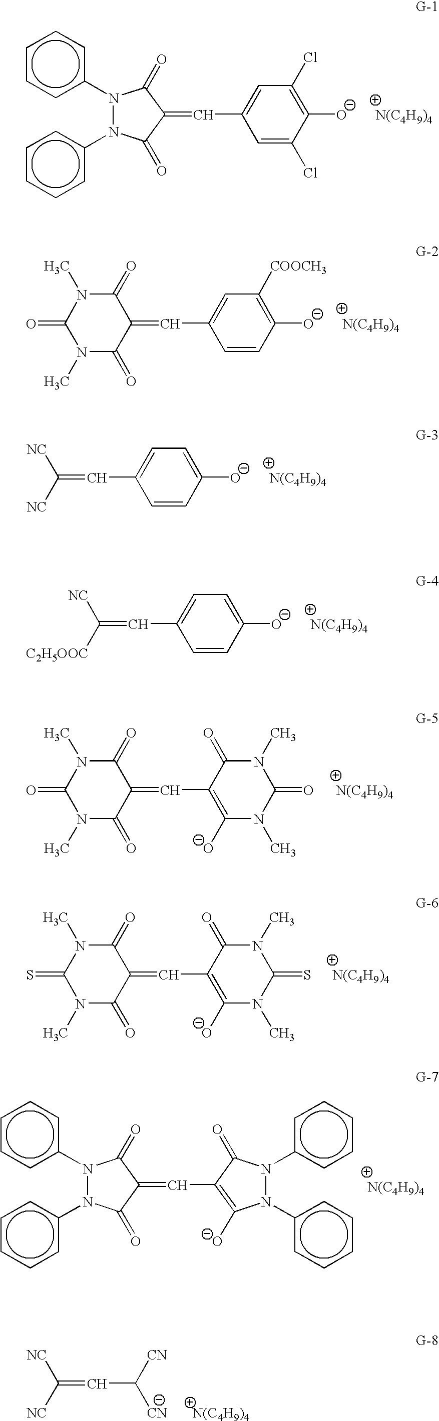

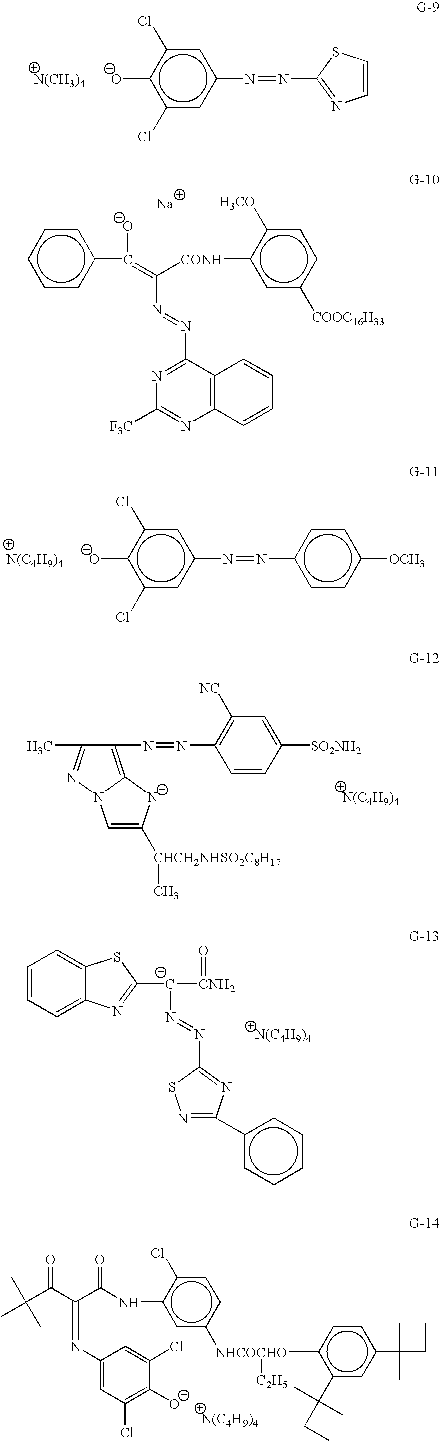

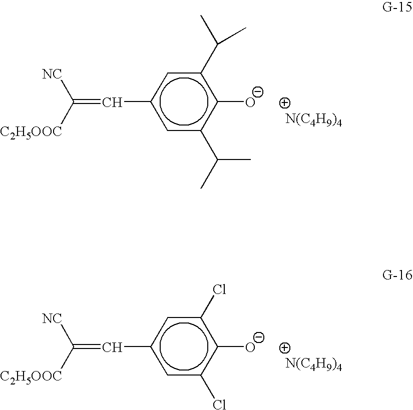

The hologram recording material of the invention preferably has the electron-donating colorless dye or diazonium salt compound (hereinafter occasionally referred to as “color-developable component”), the dissociation product of dissociative dye precursor (hereinafter occasionally referred to as “color-extinguishable component”) or the like incorporated in a microcapsule. The microcapsulization of these components can be accomplished by any known method. Examples of such a method employable herein include a method involving the utilization of coacervation of hydrophilic wall-forming material disclosed in U.S. Pat. Nos. 2,800,457 and 2,800,458, an interfacial polymerization method disclosed in U.S. Pat. No. 3,287,154, British Patent 990,443, JP-B-38-19574, JP-B-42-446 and JP-B-42-771, a method involving polymer precipitation disclosed in U.S. Pat. Nos. 3,418,250 and 3,660,304, a method involving the use of isocyanate polyol wall material disclosed in U.S. Pat. No. 3,796,669 a method involving the use of isocyanate wall material disclosed in U.S. Pat. No. 3,914,511, a method involving the use of urea-formaldehyde-based and urea formaldehyde-resorcinol-based wall-forming materials disclosed in U.S. Pat. Nos. 4,001,140, 4,087,376 and 4,089,802, a method involving the use of wall-forming material such as melamine-formaldehyde resin and hydroxypropyl cellulose disclosed in U.S. Pat. No. 4,025,455, an in situ method involving the polymerization of monomer disclosed in JP-B-36-9168 and JP-A-51-9079, an electrolysis dispersion cooling method disclosed in British Patents 952807 and 965074, a spray drying method disclosed in U.S. Pat. No. 3,111,407 and British Patent 930,422, and a method disclosed in JP-B-7-73069, JP-A-4-101885, and JP-A-9-263057.

The microcapsulization of the components is not limited to the aforementioned methods. In particular, an interfacial polymerization method is preferably employed which comprises dissolving or dispersing a color-developable or color-extinguishable component in a hydrophobic organic solvent as a capsule core to prepare an oil phase, mixing the oil phase with an aqueous phase having a water-soluble polymer dissolved therein, subjecting the mixture to emulsion dispersion by a means such as homogenizer, and then heating the emulsion dispersion so that a polymer-forming reaction occurs at the oil droplet interface to form a microcapsule wall of polymer material. The aforementioned interfacial polymerization method allows the formation of capsule having a uniform particle diameter in a short period of time, making it possible to obtain a hologram recording material having an excellent preservability.

The microcapsule which is preferably used in the invention causes its microcapsule wall (hereinafter simply referred to as “capsule wall”) to separate materials from each other and prevent the interior material and the exterior material from coming into contact with each other at ordinary temperature but allows the interior material and the exterior material to come into contact with each other when heated and/or pressured to not lower than a predetermined extent. This phenomenon can be freely controlled as a change of physical properties of capsule by properly selecting the material of the capsule wall, the material of capsule core (material contained in capsule), the additives, etc.

The material of the capsule wall employable herein is incorporated in the interior and/or exterior of the oil droplet Examples of the material of the aforementioned capsule wall include polyurethanes, polyureas, polyamides, polyesters, polycarbonates, urea-formaldehyde resins, melamine resins, polystyrenes, styrene methacrylate copolymers, and styrene-acrylate copolymers. Preferred among these materials are polyurethanes, polyureas, polyamides, polyesters, and polycarbonates. More desirable among these materials are polyurethanes and polyureas. These polymer materials may be used in combination of two or more thereof.

In the case where a polyurethane, for example, is used as a capsule wall material, a polyvalent isocyanate and a second material which reacts with the polyvalent isocyanate to form a capsule wall (e.g., polyol, polyamine) are mixed with an aqueous solution of a water-soluble polymer (aqueous phase) or an oil-soluble medium to be capsulized (oil phase). The mixture is then emulsion-dispersed in water. The emulsion dispersion is then heated so that a polymer-forming reaction occurs at the oil droplet interface to form a microcapsule wall. As the aforementioned polyvalent isocyanate and the polyol and polyamine which react therewith there may be used those disclosed in U.S. Pat. Nos. 3,281,383, 3,773,695 and 3,793,268, JP-B-48-40347, JP-B-49-24159, JP-A-48-80191, and JP-A-48-84086.

During the formation of microcapsule, the color-developable or color-extinguishable component to be incorporated in the microcapsule may be present in the form of solution or solid form in the capsule. In order to contain the color-developable or color-extinguishable component in the form of solution, an electron-donating colorless dye or diazonium salt compound which is a color-developable component and a dissociation product of dissociative dye which is a color-extinguishable component may be capsulized in tile form of solution in an organic solvent.

The aforementioned organic solvent can be normally properly selected from the group consisting of high boiling solvents. Examples of the high boiling solvent employable herein include phosphoric acid esters, phthalic acid esters, acrylic acid esters, methacrylic acid esters, other carboxylic acid esters, aliphatic acid amides, alkylated biphenyls, alkylated terphenyls, chlorinated paraffins, alkylated napthalenes, diallyl ethanes, normally solid compounds, oligomer oils, and polymer oils. Specific examples of these high boiling solvents include organic solvents disclosed in JP-A-59-178451, JP-A-59-178452, JP-A-59-178453, JP-A-59-178454, JP-A-59-178455, JP-A-59-178457, JP-A-60-242094, JP-A-63-85633, JP-A-6-194825, JP-A-7-13310, JP-A-7-13311, JP-A-9-106039, and JP-A-63-045084 (Japanese Patent Application No. 62-75409). The amount of the aforementioned organic solvent to be used is preferably from 1 to 500 parts by mass based on 100 parts by mass of the electron-donating colorless dye or dissociation product of dissociative dye. The capsulization may be effected free from the aforementioned organic solvent In other words, so-called oilless capsule may be formed.

In the case where the electron-donating colorless dye or the diazonium salt compound, dissociation product of dissociative dye, etc. have a low solubility in the aforementioned organic solvent, a low boiling solvent having a high dissolving power may be additionally used as an auxiliary solvent. On the other hand, the aforementioned low boiling solvent may be used instead of the aforementioned organic solvent. Examples of the aforementioned low boiling solvent include ethyl acetate, propyl acetate, isopropyl acetate, butyl acetate, and methylene chloride.

As the aqueous phase in which the aforementioned oil phase is emulsion-dispersed'there is used an aqueous solution having a water-soluble polymer dissolved therein. The aqueous phase to which the oil phase has been added is then subjected to emulsion dispersion by means of a homogenizer or the like. The aforementioned water-soluble polymer acts as a protective colloid capable of uniformalizing and facilitating dispersion as well as a dispersion medium for stabilizing the emulsion-dispersed aqueous solution. In order that the emulsion dispersion might be effected more uniformly to obtain a stabler dispersion, at least one of the oil phase and the aqueous phase may have a surface active agent incorporated therein.

The water-soluble polymer to be incorporated in the aforementioned protective colloid may be properly selected from the group consisting of known anionic polymers, nonionic polymers and amphoteric polymers.

As the anionic polymer there may be used any of natural and synthetic anionic polymers. Examples of these anionic polymers include those having connecting groups such as —COO— and —SO₂—. Specific examples of these anionic polymers include natural materials such as gum arabic, alginic acid and pectine, gelatin derivatives such as carboxymethyl cellulose and phthalated gelatin, semi-synthetic products such as sulfated starch, sulfated cellulose and ligninsulfonic acid, and synthetic products such as maleic anhydride-based copolymer (including hydrolyzate), acrylic acid-based (methacrylic acid-based) polymer and copolymer, vinylbenzenesulfonic acid-based polymer and copolymer and carboxy-modified polyvinyl alcohol.

Examples of the nonionic polymers include polyvinyl alcohols, polyvinyl pyrrolidones, hydroxyethyl celluloses, and methyl celluloses. Examples of the amphoteric polymers include gelatin. Preferred among these amphoteric polymers are gelatin, gelatin derivatives and polyvinyl alcohols. The aforementioned water-soluble polymer is used in the form of aqueous solution having a concentration of from 0.01 to 10% by mass.

The aforementioned surface active agent may be properly selected from the group consisting of known emulsifying surface active agents. For example, those which act as protective colloid to prevent precipitation or agglomeration as previously mentioned can be properly selected from the group consisting of anionic or nonionic surface active agents. Specific examples of these surface active agents include sodium alkylbenzene sulfonate, sodium alkylsulfate, dioctyl sodium sulfosuccinate, and polyalkylene glycol (e.g., polyoxyethylene nonyl phenyl ether). The amount of the aforementioned surface active agent to be incorporated is preferably from 0.1% to 5%, more preferably from 0.5% to 2% based on the mass of the oil phase.

All the ingredients, including color-developable and color-extinguishable components, may be used in the form of a solid dispersion with, e.g., a water-soluble polymer, a sensitizer and other color-developable or color-extinguishable components obtained using a sandmill or other means. However, it is preferred that all these ingredients be dissolved in a difficultly water-soluble or water-insoluble high boiling organic solvent, mixed with an aqueous solution of a polymer (aqueous phase) containing a surface active agent and/or a water-soluble polymer, and then emulsified using a homogenizer or the like to form an emulsion dispersion. In this case, a low boiling solvent may be used as a dissolving aid as necessary. Further, all the ingredients, including color-developable and color-extinguishable components, may be separately emulsion-dispersed. Alternatively, all these ingredients may be mixed, dissolved in a high boiling solvent and/or a low boiling solvent, and then emulsion dispersed. The resulting emulsion dispersion preferably has a particle diameter of 1 μm or less.

The aforementioned emulsion dispersion can be easily attained by subjecting an oil phase containing the aforementioned components and an aqueous phase containing a surface active agent and/or a protective colloid to emulsion dispersion using a means for fine emulsification such as high speed agitation and ultrasonic dispersion, e.g., known emulsifier such as homogenizer, Manton-Gaulin, ultrasonic dispersing machine, dissolver and KD mill.

The emulsion thus obtained is then heated to a temperature of from 30° C. to 70° C. for the purpose of accelerating the capsule wall-forming reaction. During the reaction, it is necessary that water be added to the reaction mixture to lower the provability of collision of capsules to each other or be thoroughly stirred so that the agglomeration of capsules can be prevented. On the other hand, a dispersion for preventing agglomeration may be separately added during the reaction. The end point of the aforementioned capsule wall-forming reaction can be roughly recognized by the termination of the generation of carbon dioxide gas observed with the progress of the polymerization reaction. In general, the capsule wall-forming reaction can be effected for several hours to obtain a microcapsule having a color-developable or color-extinguishable component incorporated therein.

In the invention, the average particle diameter of the microcapsules is preferably 1 μm or less, more preferably 0.5 μm or less, most preferably 0.2 μm or less from the standpoint of enhancement of resolution (diffraction efficiency).

As the substantially colorless compound B comprising a polymerizable group having an ethylenically unsaturated bond and a site which reacts with the aforementioned color-developable or color-extinguishable component A to cause color development or color extinction in the same molecule, which compound B to be incorporated in the photosensitive thermosensitive recording layer in the hologram recording material of the invention, there may be any compound which is capable of reacting with the aforementioned color-developable or color-extinguishable component A to cause color development or color extinction as well as reacting with light to cause polymerization and curing, such as electron-accepting compound having a polymerizable group and coupler compound having a polymerizable group.

As the electron-accepting compound having a polymerizable group, i.e., compound having an electron-accepting group and a polymerizable group in the same molecule, there may be used any compound which reacts with an electron-donating colorless dye which is one of the aforementioned color-developable components A to develop color or reacts with a dissociation product of dissociative dye which is one of the aforementioned color-extinguishable components A to extinguish color and undergoes photopolymerization to cure the film. Examples of the aforementioned electron-accepting compound include 3-halo-4-hydroxybenzoic acids disclosed in JP-A-4-226455, methacryloxyethyl esters and acryloxyethyl esters of benzoic acid having hydroxyl group disclosed in JP-A-63-173682, esters of benzoic acid with hydroxymethylstyrene having hydroxyl group disclosed in JP-A-59-83693, JP-A-60-141587 and JP-A-62-99190, hydroxystyrenes disclosed in EP 29323, N-vinylimidazole complexes of halogenated zinc disclosed in JP-A-62-167077 and JP-A-62-16708, and compounds which can be synthesized according to electron-accepting compounds disclosed in JP-A-63-317558. Preferred among these compounds having an electron-accepting group and a polymerizable group in the same molecule are 3-halo-4-hydroxybenzoic acids represented by the following general formula: 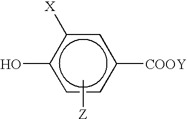
wherein X represents a halogen atom, preferably chlorine atom; Y represents a monovalent group having a polymerizable ethylene group, preferably aralkyl, acryloyloxyalkyl or methacryloyloxyalkyl group having vinyl group, more preferably C5-C11 acryloyloxyalkyl group or C6-C12 methacryloyloxyalkyl group; and Z represents a hydrogen atom, alkyl group or alkoxyl group.

Examples of the aforementioned 3-halo-4-hydroxy benzoic acids include 3-chloro-4-hydroxybenzoic acid ester vinyl phenethyl ester, 3-chloro-4-hydroxybenzoic acid vinyl phenyl propyl ester, 3-chloro-4-hydroxy benzoic acid-(2-acryloyloxyethyl)ester, 3-chloro-4-hydroxybenzoic acid-(2-methacryloyloxyethyl)ester, 3-chloro-4-hydroxybenzoic acid-(2-acryloyloxypropyl)ester, 3-chloro-4-hydroxybenzoic acid-(2-methacryloyl oxypropyl)ester, 3-chloro-4-hydroxybenzoic acid-(3-acryloxypropyl)ester, 3-chloro-4-hydroxybenzoic acid-(3-methacryloyloxypropyl)ester, 3-chloro-4-hydroxybenzoic acid-(4-acryloyloxybutyl)ester, 3-chloro-4-hydroxybenzoic acid-(4-methacryloyl oxybutyl)ester, 3-chloro-4-hydroxybenzoic acid-(5-acryloyloxypentyl)ester, 3-chloro-4hydroxybenzoic acid-(5-methacryloyloxypentyl)ester, 3-chloro-4-hydroxybenzoic acid-(6-acryloyloxyhexyl)ester, 3-chloro-4-hydroxybenzoic acid(6-methacryloxyhexyl)ester, 3-chloro-4-hydroxybenzoic acid-(8-acryloyloxy octyl)ester, and 3-chloro-4-hydroxybenzoic acid-8-methacryloyloxyoctyl)ester.

Further examples of preferred compound having an electron-accepting group and a polymerizable group in the same molecule include styrenesulfonylaminosalicylic acid, vinylbenzyloxyphthalic acid, zinc β-methacryloxy ethoxysalicylate, zinc β-acryloxyethoxysalicylate, vinyloxyethyloxybenzoic acid, β-methacryloxyethyl orselinate, β-acryloxyethyl orselinate, β-methacryloxy ethoxy phenol, β-acryloxyethoxy phenol, β-methacryloxy ethyl-β-resorcinate, β-acryloxyethyl-β-resorcinate, hydroxystyrenesulfonic acid-N-ethylamide, β-methacryloxypropyl-p-hydroxybenzoate, β-acryloxy propyl-p-hydroxybenzoate, methacryloxymethylphenol, acryloxymethylphenol, methacrylamidepropanesulfonic acid, acrylamidepropanesulfonic acid, β-methacryloxy ethoxy-dihydroxybenzene, β-acryloxyethoxy-dihydroxybenzene, γ-styrenesulfonyloxy-β-methacryloxy propanccarboxylic acid, γ-acryloxypropyl-α-hydroxyethyloxysalicylic acid, β-hydroxyethoxyphenol, β-methacryloxyethyl-p-hydroxy cinnamate, β-acryloxyethyl-p-hydroxy cinnamate, 3,5-distyrenesulfonic acid amidephenol, methacryloxyethoxy phthalic acid, acryloxyethoxyphthalic acid, methacrylic acid, acrylic acid, methacryloxyethoxyhydroxynaphtoic acid, acryloxyethoxyhydroxynaphtoic acid, 3-β-hydroxy ethoxyphenol, β-methacryloxyethyl-p-hydroxybenzoate, and β-acryloxyethyl-p-hydroxybenzoate, β′-methacryloxyethyl-β-resorcinate, β-methacryloxy ethyloxycarbonylhydroxybenzoic acid, β-acryloxy ethyloxycarbonylhydroxybenzoic acid, N,N′-di-β-methacryloxyethylaminosalicylic acid, N,N′-di-β-acryloxycthylaminosalicylic acid, N,N′-di-β-methacryloxyethylaminosulfonylsalicylic acid, N, N′-di-β-acryloxyethylaminosulfonylsalicylic acid, and salts thereof with metal (e.g., zinc).

The aforementioned electron-accepting compound having a polymerizable group is used in combination with the aforementioned electron-donating colorless dye or dissociation product of dissociative dye. In this case, the amount of the electron-accepting compound to be used is preferably from 0.5 to 20 parts by mass, more preferably from 3 to 10 parts by mass based on 1 part by mass of the electron-donating colorless dye or dissociation product of dissociative dye used. When the amount of the electron-accepting compound to be used falls below 0.5 parts by mass, the resulting color development or color extinction, i.e., refractive index modulation cannot be sufficient. When the amount of the electron-accepting compound to be used exceeds 20 parts by mass, it can occasionally cause the drop of sensitivity or the deterioration of spreadability.

As the aforementioned coupler compound having a polymerizable group there may be used any compound having a polymerizable group which can react with a diazonium salt compound as one of the aforementioned color-developable components A to cause color development and undergo photopolymerization to cure the film. The coupler compound undergoes coupling with a diazo compound in a basic atmosphere and/or neutral atmosphere to form a dye. A plurality of such coupler compounds may be used in combination depending on various purposes such as hue adjustment. Specific examples of these coupler compounds will be given below, but the invention is not limited thereto.

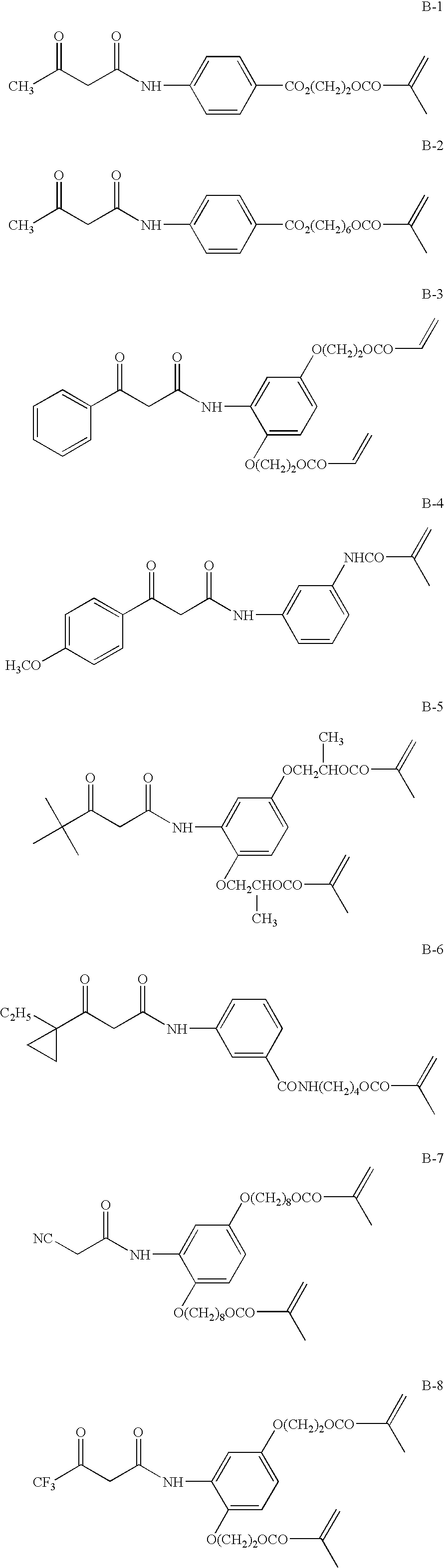

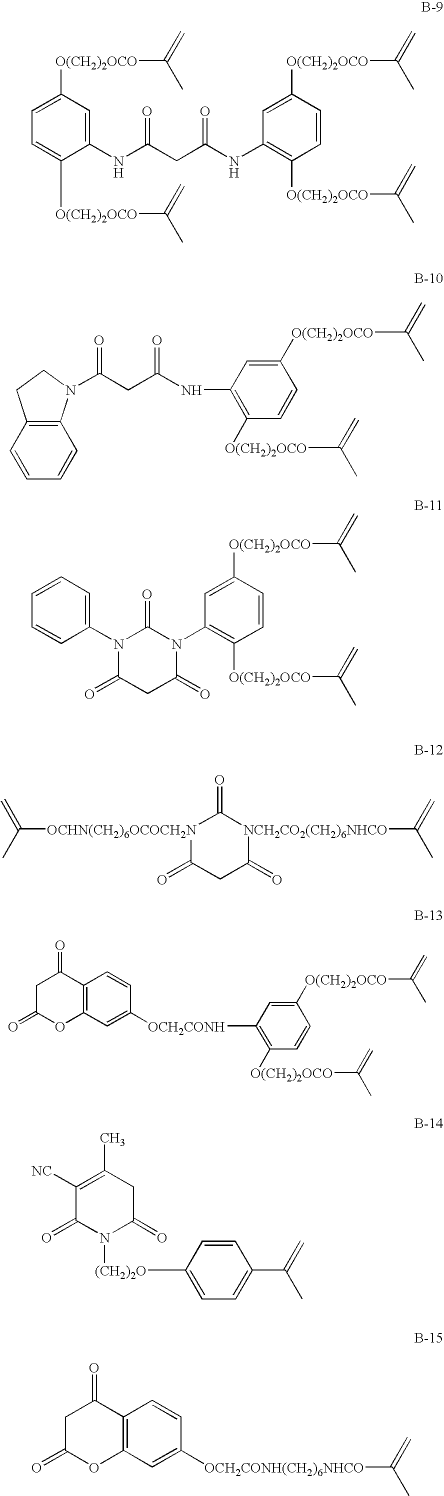

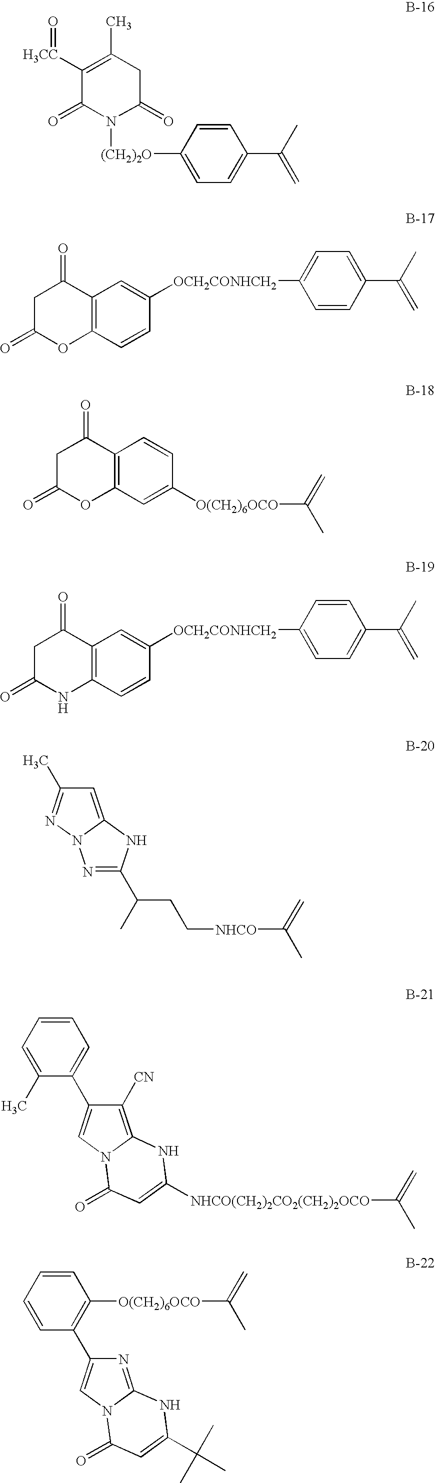

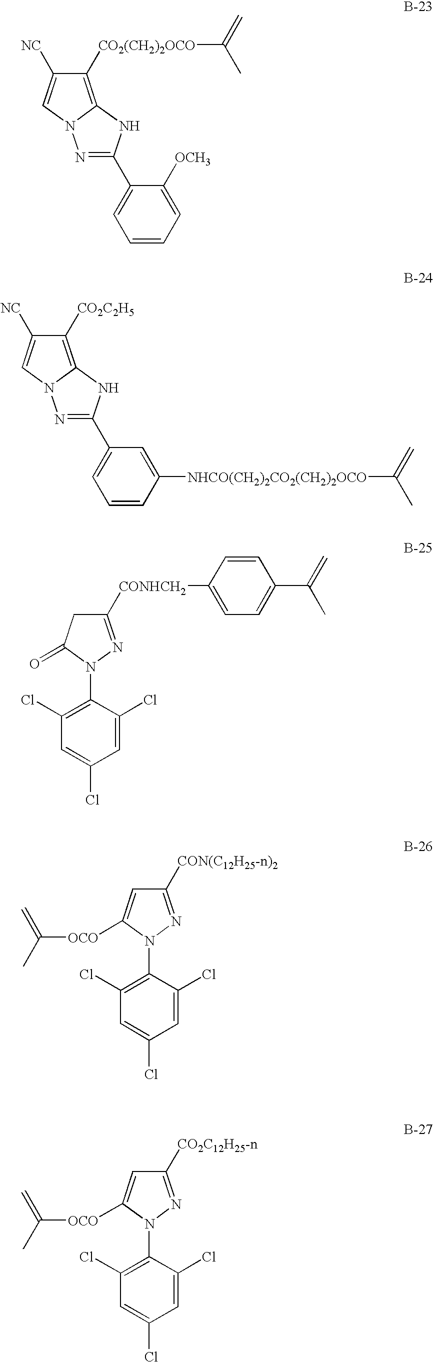

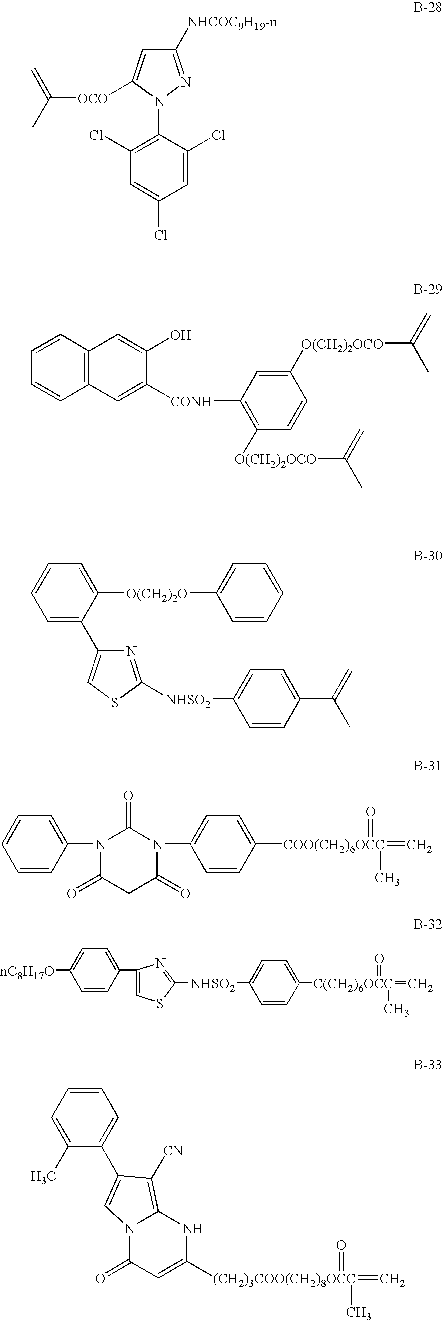

The aforementioned coupler compound is used in combination with the diazonium salt compound. The amount of the aforementioned coupler compound to he incorporated in the photosensitive thermosensitive recording layer in the hologram recording material of the invention is preferably from 0.02 to 5 g/m², more preferably from 0.1 to 4 g/m² from the standpoint of effectiveness. When the amount of the coupler compound to be incorporated in the photosensitive thermosensitive recording layer falls below 0.02 g/m², the resulting hologram recording material occasionally exhibits deteriorated color developability. When the amount of the coupler compound to be incorporated in the photosensitive thermosensitive recording layer exceeds 5 g/m2, the resulting coating solution occasion-ally exhibits deteriorated spreadability

The amount of the coupler compound to be used is preferably from 0.5 to 20 parts by mass, more preferably from 1 to 10 parts by mass based on 1 part by mass of the diazonium salt compound. When the amount of the coupler compound to be used falls below 0.5 parts by mass, the resulting color development, i.e., refractive index modulation cannot be sufficient. When the amount of the coupler compound to be used exceeds 20 parts by mass, the coating solution occasionally exhibits deteriorated spreadability.

The coupler compound may be used in the form of a solid dispersion obtained by dispersing the coupler compound with other components and a water-soluble polymer using a sandmill or the like. Alternatively, the coupler compound may be used in the form of an emulsion obtained by emulsifying the coupler compound with an auxiliary emulsifier. The solid dispersion or emulsification method is not specifically limited and may be properly selected from the group consisting of known methods. For the details of these methods, reference can be made to JP-A-59-190886, JP-A-2-141279, and JP-A-7-17145.

For the purpose of accelerating coupling reaction, an organic base is preferably used. Examples of the organic base employable herein include tertiary amines, piperidines, piperidines, amidines, formamidines, pyridines, guanidines, and morpholines disclosed in JP-A-57-123086, JP-A-6049991, JP-A-60-94381, JP-A-9-71048 (Japanese Patent Application No. 7-228731), JP-A-9-77729 (Japanese Patent Application No. 7-235157), and JP-A-9-77737 (Japanese Patent Application No. 7-235158). The aforementioned organic bases may be used singly or in combination of two or more thereof. The amount of the organic base to be used is not specifically limited but is preferably from 1 to 30 mols per mol of diazonium salt.

Further, a color development or color extinction aid may be added for the purpose of accelerating the color development or color extinction reaction. Examples of the aforementioned color development or color extinction aid include phenol derivatives, naphthol derivatives, alkoxy-substituted benzenes, alkoxy-substituted naphthalenes, hydroxy compounds, carboxylic acid amide compounds, and sulfonamide compounds. It is thought that these compounds act to cause the drop of the melting point of the coupler compound or basic material or enhance the heat permeability of the microcapsule wall, making it possible to obtain a high density of color developed or extinguished, i.e., high refractive index modulation.

In the invention, instead of the compound B having a polymerizable group as the compound which reacts with the aforementioned color-developable or color-extinguishable component A to cause color development or color extinction there may be used a substantially colorless polymerizable group-free compound C which reacts with the color-developable or color-extinguishable component A to cause color development or color extinction instead of the aforementioned compound having a polymerizable group. However, since the aforementioned compound C is free of polymerizable group, it is used in combination with a substantially colorless compound D having a polymerizable group having at least one ethylenically unsaturated bond and a site which inhibits the reaction of the aforementioned color-developable or color-extinguishable component A with the compound C in the same molecule (hereinafter occasionally referred to as “compound D having polymerizable group”) for the purpose of rendering the recording layer capable of curing by photopolymerization.

As the aforementioned compound D having a polymerizable group there may be used the already described photopolymerizable monomer D1 or D2. Any suitable compound D may be properly used depending on the kind of the compound C which is incorporated as a color-developable or color-extinguishable component. Combinations of the compound C which is incorporated as a color-developable or color-extinguishable component and the compound D adapted for the compound C will be successively described later.

As the aforementioned compound C there may be used any electron-accepting compound or coupler compound free of polymerizable group. As the electron-accepting compound free of polymerizable group there may be used any compound which can react with an electron-donating colorless dye or dissociation product of dissociative dye which is one of the aforementioned color-developable or color-extinguishable components A to cause color development or color extinction.

Examples of the electron-accepting compound free of polymerizable group include phenol derivatives, salicylic acid derivatives, metal salts of aromatic carboxylic acid, acidic clay, bentonite, novolac resins, metal-treated novolac resins, and metal complexes. For the details of these electron-accepting compounds free of polymerizable group, reference can be made to JP-B-40-9309, JP-B-45-14039, JP-A-52-140483, JP-A48-51510, JP-A-57-210886, JP-A-58-87089, JP-A-59-11286, JP-A-60-176795, and JP-A-61-95988.

Specific examples of tie aforementioned compounds will be given below. Examples of the phenol derivatives include 2,2′-bis(4-hydroxyphenyl)propane, 4-t-butyl phenol, 4-phenylphenol, 4-hydroxydiphenoxide, 1,1′-bis(3-chloro-4-hydroxyphenyl)cyclohexane, 1,1′-bis(4-hydroxyphenyl)cyclohexane, 1,1′-bis(3-chloro-4-hydroxyphenyl)-2-ethylbutane, 4,4′-sec-isooctylidene diphenyl, 4,4′-sec-butylidenediphenol, 4-tert-octyl phenol, 4-p-metulylphenylpehnol, 4,4′-methylcyclo hexylidenephenol, 4,4′-isopentylidenephenol, and p-hydroxybenzoic acid benzyl.

Examples of the salicylic acid derivatives include 4-pentadecylsalicylic acid, 3,5-di(α-methylbenzyl) salicylic acid, 3,5-di(tert-octyl)salicylic acid, 5-octadecylsalicylic acid, 5-α-(p-α-methylbenzylphenyl)ethylsalicylic acid, 3-α-methylbenzyl-5-tert-octyl salicylic acid, 5-tetradecylsalicylic acid, 4-hexyloxy salicylic acid, 4-cyclohexyloxysalicylic acid, 4-decyl oxysalicylic acid, 4-dodecyloxysalicylic acid, 4-penta decyloxysalicylic acid, 4-octadecyloxysalicyclic acid, and salts thereof with zinc, aluminum, calcium, copper and lead.

The amount of the aforementioned electron-accepting compound free of polymerizable group to be used is preferably from 5 to 1,000% by mass based on the amount of the electron-donating colorless dye to be used.

In the case where the aforementioned electron-accepting compound free of polymerizable group is used, the already described photopolymerizable monomer D1 is additionally used as the compound D having a polymerizable group. The aforementioned photopolymerizable monomer D1 is preferably a photopolymerizable monomer having at least one vinyl group per molecule which acts to inhibit the reaction of the electron-donating colorless dye with the electron-accepting compound.

The amount of the aforementioned photopolymerizable monomer D1 to be incorporated in the photosensitive thermosensitive recording layer in the hologram recording material of the invention is preferably from 0.1 to 10 parts by mass, more preferably from 0.5 to 5 parts by mass based on 1 part by mass of the substantially colorless compound C which reacts with the aforementioned color-developable or color-extinguishable component A to cause color development or color extinction. When the amount of the aforementioned photopolymerizable monomer D1 to be incorporated in the photosensitive thermosensitive recording layer falls below 0.1 parts by mass, a latent image cannot be occasionally formed at the holographic exposure step. When the amount of the aforementioned photopolymerizable monomer D1 to be incorporated in the photosensitive thermosensitive recording layer exceeds 10 parts by mass, the density of color developed or extinguished, i.e., refractive index modulation can be lowered.

As the aforementioned coupler compound free of polymerizable group there may be used any compound which can react with a diazonium salt compound which is one of the aforementioned color-developable components A to cause color development. The coupler compound free of polymerizable group undergoes coupling with the diazonium compound in a basic atmosphere and/or neutral atmosphere to form a dye. A plurality of these coupler compounds can be used depending on various purposes such as hue adjustment.

Examples of the coupler compound free of polymerizable group include so-called active methylene compounds having methylene group adjacent to carbonyl group, phenol derivatives, and naphthol derivatives. These coupler compounds may be properly selected so far as they comply with the aim of the invention.

Examples of the aforementioned coupler compounds free of polymerizable group include resorcine, Phloroglucin, 2,3-dihydroxynaphthalene, sodium 2,3-dihydroxy naphthalene-6-sulfonate, 1-hydroxy-2-naphtoic acid morpholinopropylamide, sodium 2-hydroxy-3-naphthalenesulfonate, 2-hydroxy-3-naphthalene sulfonic acid anilide, 2-hydroxy-3-naphthalenesulfonic acid morpholinopropylamide, 2-hydroxy-3-naphthalene sulfonic acid-2-ethylhexyloxypropylamide, 2-hydroxy-3-naphthalenesulfonic acid-2-ethylhexylamide, 5-acetamide-1-naphthol, sodium 1-hydroxy-8-acetamidenaphthalene-3,6-disulfonate, 1-hydroxy-8-acetamidenaphthalene-3,6-disulfonic acid anilide, 1,5-dihydroxynaphthalene, 2-hydroxy-3-naphthoic acid morpholinopropylamide, 2-hydroxy-3-naphthoic acid octylamide, 2-hydroxy-3-naphthoic acid anilide, 5,5-dimethyl-1,3-cyclohexane dione, 1,3-cyclopentadione, 5-(2-n-tetradccyloxy phenyl)-1,3-cyclohexanedione, 5-phenyl-4-methoxy carbonyl-1,3-cyclohexanedione, 5-(2,5-di-n-octyloxy phenyl)-1,3-cyclohexanedione, N,N′-dicyclohexyl barbituric acid, N,N′-di-n-dodecylbarbituric acid, N-n-octyl-N′-n-octadecylbarbituric acid, N-phenyl-N′-(2,5di-n-octyloxyphenyl)barbituric acid, N,N′-bis(octadecyloxycarboylmethyl)barbituric acid, 1-phenyl-3-methyl-5-pyrazolone, 1-(2,4,6-trichlorophenyl)-3-anilino-5-pyrazolone, 1-(2,4,6-trichlorophenyl)-3-benzamide-5-pyrazolone, 6-hydroxy-4-methyl-3-cyano-1-(2-ethylhexyl)-2-pyridone, 2,4-bis(benzoylacetamide)toluene, 1,3-bis(pivaolylacetamidemethyl)benzene, benzoylacetonitrile, tenoylacetonitrile, acetoacetoanilide, benzoylacetoanilide, pivaloylacetoanilide, 2-chloro-5-(N-n-butylsulfamoyl)-1-pivaloylacctamidebenzene, 1-(2-thylhexyloxy propyl)-3-cyano-4-methyl-6-hydroxy-1,2-dihydro pyridine-2-one, 1-(dodecyloxypropyl)-3-acetyl-4-methyl-6-hydroxy-1,2-dilydropyridine-2-one, and 1-(4-n-octyloxyphenyl)-3-tert-butyl-5-aminopyrazole.

For the details of the coupler compound free of polymerizable group, reference can be made to JP-A4-201483, JP-A-7-223367, JP-A-7-223368, JP-A-7-323660, JP -A-5-278608, JP-A-5-297024, JP-A-6-18669, JP-A-6-18670, and JP-A-7-316280. Reference can be made also to JP-A-9-216468 (Japanese Patent Application No. 8-027095), JP-A-9-216469 (Japanese Patent Application No. 8-027096), Japanese Patent Application No. 8-030799, JP-A-9-319025 (Japanese Patent Application No. 8-132394), JP-A-10-35113 (Japanese Patent Application No. 8-358755), JP-A-10-193801 (Japanese Patent Application No. 8-358756) and JP-A-10-264532 (Japanese Patent Application No. 9-069990), which have been early filed by the present applicant.

The amount of the coupler compound free of polymerizable group to be incorporated in the photosensitive thermosensitive recording layer of the hologram recording material of the invention is the same as that of the coupler compound having a polymerizable group. The coupler compound free of polymerizable group may be used in the form of solid dispersion or emulsion similarly to the aforementioned coupler compound having a polymerizable group. The solid dispersion or emulsification of the coupler compound free of polymerizable group can be carried out by the same method as that of the coupler compound having a polymerizable group. For the purpose of accelerating the coupling reaction, the same organic base as used in the case of the aforementioned coupler compound having a polymerizable group may be used in the same amount as defined in that case. As the color development aid to be used for the purpose of accelerating the color development reaction there may be used the same compound as used in the case of the aforementioned coupler compound having a polymerizable group.

The aforementioned coupler compound free of polymerizable group, if any, is used in combination with the already described photopolymerizable monomer D2 as compound D having a polymerizable group D. The aforementioned photopolymerizable monomer D2 is preferably a photopolymerizable monomer which has an acidic group having an effect of inhibiting the coupling reaction and is not a metal salt compound. The amount of the aforementioned photopolymerizable monomer D2 to be incorporated in the photosensitive thermosensitive recording layer is the same as in the case of the aforementioned photopolymerizable monomer D1.

The photosensitive thermosensitive recording layer of the hologram recording material of the invention comprises a photopolymerization initiator incorporated therein besides the aforementioned color-developable or color-extinguishable component A, compound B or compound C or D. As the photopolymerization initiator there may be used the same photopolymerization initiator as can be used in the aforementioned photopolymerizable composition. The amount of the spectral sensitizing dye to be incorporated in the photosensitive thermosensitive recording layer is preferably from 0.1 to 5% by mass, more preferably from 0.2 to 2% by mass based on the total dried mass of the photosensitive thermosensitive recording layer.

As the compound having mutual interaction with the spectral sensitizing dye in the photopolymerization initiator there may be used one or more properly selected from the group consisting of known compounds capable of initiating the photopolymerization reaction with the photopolymerizable group in the aforementioned compound B or the compound D (photopolymerizable monomer D1, D2). In some detail, the compound having mutual interaction with the spectral sensitizing dye can be properly selected from the already described compounds. Referring to tile amount of the compound having mutual interaction with the spectral sensitizing dye to be used, the compound having mutual interaction with the spectral sensitizing dye may be used in the predetermined mixing ratio with the spectral sensitizing dye in the photopolymerization initiator contained in the aforementioned photopolymerizable composition as already described. Further, the photosensitive thermosensitive recording layer may comprise already described other components usable in the photopolymerizable composition incorporated therein.

The embodiment of the hologram recording material having a photosensitive thermosensitive recording layer provided on a support as mentioned above is not limited to the aforementioned photosensitive thermosensitive hologram recording material (a) or (b) but may have various configurations depending on the purpose. In other words, the hologram recording material may undergo not only monochromatic refractive index modulation but also polychromatic refractive index modulation. Further, if necessary, a protective layer may be provided on the outermost layer, that is on the photosensitive thermosensitive recording layer, i.e., on the side of the hologram recording material on which light is incident The aforementioned polychromatic hologram recording material may be a multi-layered hologram recording material having a plurality of monochromatic recording layers laminated on each other. An interlayer may be provided interposed between these recording layers. The aforementioned protective layer may have a single layer structure or a laminated structure having two or more layers laminated on each other.

Examples of the material of the aforementioned protective layer include water-soluble polymer compounds such as gelatin, polyvinyl alcohol, carboxy-modified polyvinyl alcohol, vinyl acetate-acrylamide copolymer, silicon-modified polyvinyl alcohol, starch, modified starch, methyl cellulose, carboxymethyl cellulose, hydroxymethyl cellulose, gelatin, gum arabic, casein, hydrolyzate of styrene-maleic acid copolymer, hydrolyzate of styrene-maleic acid copolymer half ester, hydrolyzate of isobutylene-maleic anhydride copolymer, polyacrylamide derivative, polyvinyl pyrrolidone, sodium polystyrenesulfonate and sodium alginate, and latexes such as styrene-butadiene rubber latex, acrylonitrile-butadiene rubber latex, methyl acrylate-butadiene rubber latex and vinyl acetate emulsion.

By crosslinking the water-soluble polymer compound incorporated in the aforementioned protective layer, the storage stability of the hologram recording material can be further enhanced. As the crosslinking agent to be used in crosslinking there may be used any known crosslinking agent. Specific examples of these crosslinking agents include water-soluble initial condensates such as N-methyloluraa, N-methylolmelamine and urea-formaline, dialdehyde compounds such as glyoxal and glutaraldehyde, inorganic crosslinking agents such as boric acid and borax, and polyamideepichlorohydrin.

The aforementioned protective layer may further comprise a known pigment, metal soap, wax, surface active agent, fluorescent brightening agent, etc. incorporated therein. Further, a UV absorber or UV absorber precursor such as hydroxyphenylbenzotriazole-based compound, hyroxybenzophenone-based compound and hydroxyphenyl triazine-based compound may be added.

The spread (dried) of the aforementioned protective layer is preferably from 0.2 to 5 g/m², more preferably from 0.5 to 3 g/m².

The polychromatic hologram recording material, if used, can be formed by laminating a plurality of monochromatic recording layers on each other on a support. By incorporating in the various recording layers microcapsules containing color-developable or color-extinguishable components having different hues of color developed or extinguished and photopolymerizable compositions which are sensitive to light having different wavelengths, a polychromatic multi-layered hologram recording material can be formed. When irradiated with light, the various recording layers are sensitive to light having respective wavelength. As a whole, refractive index modulation by polychromatic color development occurs to form interference fringes. The aforementioned photopolymerizable composition comprises spectral sensitizing dyes having different absorption wavelengths so that it is sensitive to light having different wavelengths. In this case, an interlayer may be provided interposed between the monochromatic recording layers as already described.

The interlayer provided interposed between the monochromatic recording layers is mainly composed of a binder which may comprise additives such as hardener, polymer latex, filter dye, mica and ultraviolet absorber incorporated therein as necessary.

In an oil-in-water droplet dispersion method, the aforementioned filter dye is dissolved in one or a mixture of a high boiling solvent having a boiling point of 175° C. or more and a low boiling solvent having a boiling point of from 30° C. to 160° C. The solution is then finely dispersed in water or an aqueous solution of gelatin or polyvinyl alcohol in the presence of a surface active agent. As the aforementioned high boiling solvent there may be used a solvent disclosed in U.S. Pat. No. 2,322,027. Examples of the high boiling solvent and low boiling solvent employable herein include the same solvents as used in the preparation of the aforementioned microcapsule.

Specific examples of the step of polymer dispersion and curing and dipping latexes include those disclosed in U.S. Pat. No. 4,199,383, West German Patent Application Disclosure (OLS) 2,541,274 and 2,541,230, JP-A49-74538, JP-A-51-59943 and JP-A-54-32552, and “Research Disclosure Vol. 148”, Item 14850, August 1976.

Preferred among these latexes are copolymer latexes of acid monomer such as acrylic acid esters and methacrylic acid esters such as ethyl acrylate, n-butyl acrylate, n-butyl methacrylate and 2-acetoacetoxyethyl methacrylate, acrylic acid and 2-acrylamide-2-methyl propanesulfonic acid.

—Other Components—

The various layers such as protective layer, photosensitive thermosensitive recording layer and interlayer constituting the hologram recording material each normally comprise a binder incorporated therein. As such a binder there may be used the same binder as used in the emulsion dispersion of the aforementioned photopolymerizable composition or the water-soluble polymer (further described later) to be used in the capsulization of the color-developable or color-extinguishable component. Besides these binder materials, solvent-soluble polymers such as acrylic resin, e.g., polystyrene, polyvinyl formal, polyvinyl butyral, polymethyl acrylate, polybutyl acrylate, polymethyl methacrylate, polybutyl methacrylate, copolymer thereof, phenolic resin, styrene-butadiene resin, ethyl cellulose, epoxy resin and urethane resin, and polymer latexes thereof may be used. Preferred among these binder materials are gelatin and polyvinyl alcohol.

The various recording layers constituting the hologram recording material each may comprise various surface active agents incorporated therein for various purposes such as facilitation of spreading, prevention of static charging, improvement of slipperiness, emulsion dispersion and prevention of adhesion. Examples of the aforementioned surface active agents include nonionic surface active agents such as saponin and polyethylene oxide derivative (e.g., polyethylene oxide and alkyl ether of polyethylene oxide), anionic surface active agents such as alkylsulfonate, alkylbenzenesulfonate, alkylnaphthalenesulfonate, alkylsulfuric acid ester, N-acyl-N-alkyltauric acid, sulfosuccinic acid ester and sulfoalkylpolyoxyethylene alkylphenyl ether, amphoteric surface active agents such as alkylbetaine and alkylsulfobetaine, and cationic surface active agents such as aliphatic and aromatic quaternary ammonium salt and aromatic quaternary ammonium salt.

The various recording layers may comprise additives such as dye, ultraviolet absorber, plasticizer, fluorescent brightening agent, matting agent, coating aid, hardener, antistatic agent and slipperiness improver incorporated therein as necessary. For specific examples of these additives, reference can be made to “Research Disclosure”, Vol. 176, Item 17643, December 1978, and Vol. 187, Item 18716, November 1979.

The hologram recording material to be used in the invention preferably also has a hardener incorporated in the various layers such as photosensitive thermosensitive recording layer, interlayer and protective layer. It is particularly preferred that the protective layer comprise a hardener incorporated therein to lower the adhesivity thereof. As the aforementioned hardener there may be used a “gelatin hardener” for use in the production of photographic light-sensitive materials. Other examples of the hardener employable herein include aldehyde-based compounds such as formaldehyde and glutaraldehyde, reactive halogen compounds disclosed in U.S. Pat. No. 3,635,718, reactive compounds having ethylenically unsaturated group disclosed in U.S. Pat. No. 3,635,718, aziridine-based compounds disclosed in U.S. Pat. No. 3,017,280, halogenocarboxyaldehydes such a epoxy-based compound and mucochloric acid and dioxanes such as dihydroxydioxane and dichlorodioxane disclosed in U.S. Pat. No. 3,091,537, vinylsulfones disclosed in U.S. Pat. Nos. 3,642,486 and 3,687,707, vinylsulfone precursors disclosed in U.S. Pat. No. 3,841,872, and ketovinyls disclosed in U.S. Pat. No. 3,640,720. As inorganic hardeners there may be used chrome alum, zirconium sulfate, boric acid, etc.

Preferred among these compounds are 1,3,5-triacryloyl-hexahdydro-s-triazine, 1,2-bisvinyl sulfonylmethane, 1,3-bis(vinylsulfonylmethyl)propanol-2,bis(α-vinylsulfonylacctamide)ethane, 2,4-dichloro-6-hydroxy-s-triazine sodium salt, 2,4,6-triethylenamino-s-triazine, and boric acid. The amount of the aforementioned hardener to be incorporated in the layers is preferably from 0.5 to 5% by mass based on the amount of the binder used.

The hologram recording material of the invention can be prepared by optionally dissolving the aforementioned various components in a solvent to prepare a photosensitive thermosensitive recording layer coating solution, a protective layer coating solution, etc., and they spreading these coating solutions over desired supports on which they are then dried. Examples of the aforementioned solvent include water, alcohols such as methanol, ethanol, n-propanol isopropanol, n-butanol, sec-butanol, methyl cellosolve and 1-methoxy-2-propanol, halogen-based solvents such as methylene chloride and ethylene chloride, ketones such as acetone, cyclohexanone and methyl ethyl ketone, esters such as methyl acetate, ethyl acetate and methyl acetate, toluene, and xylene. These solvents may be used singly or in admixture of two or more thereof. Particularly preferred among these solvents is water.

Examples of the coating means for spreading the photosensitive thermosensitive recording layer coating solution include blade coater, rod coater, knife coater, roll doctor coater, reverse roll coater, transfer roll coater, gravure coater, kiss roll coater, curtain coater, and extrusion coater. For the details of the spreading method, reference can be made to “Research Disclosure”, Vol. 200, Item 20036, Clause XV, December 1980. The thickness of the photosensitive thermosensitive recording layer is preferably from 0.1 μm to 50 μm, more preferably from 5 μm to 35 μm.

Examples of the support to be used in the hologram recording material of the invention include synthetic papers such as neutral paper, acidic paper, coated paper and laminated paper, films such as polyethylene terephthalate film, cellulose triacetate film, polyethylene film, polystyrene film and polycarbonate film, sheet of metal such as aluminum, zinc and copper, dried glass sheet, and support materials obtained by subjecting these support materials to various treatments such as surface treatment, undercoating and metal vacuum deposition. Support materials disclosed in “Research Disclosure”, Vol. 200, Item 20036, Clause XVII, December 1980 can also be used. The aforementioned various support materials may also comprise a fluorescent brightening agent, a bluing dye, a pigment, etc. incorporated therein.

In the case where a reflection-type hologram is prepared, the support to be used in the hologram recording material of the invention is preferably transparent. Preferred examples of the transparent support employable herein include polyethylene terephthalate film, cellulose triacetate film, polycarbonate film, and dried glass sheet.

If necessary, an antihalation layer may be provided interposed between the support and the photosensitive thermosensitive recording layer. A slippery layer, an antistatic layer, an anti-curling layer, an adhesive layer, etc. may be provided on the surface of the support (opposite the photosensitive thermosensitive recording layer). An adhesive layer may be provided interposed between the support and the photosensitive thermosensitive recording layer to form a seat type configuration such that the support is used as release paper.

In the case where an antihalation layer is provided between the support and the photosensitive thermosensitive recording layer or, in the case of transparent support, on the surface of the support opposite the photosensitive thermosensitive recording layer, the antihalation layer may be of photo- or thermo-bleachable type.

In the case where a layer which can be bleached when irradiated with light is provided, a combination of the aforementioned spectral sensitizing dye and borate compound (combination of the spectral sensitizing dye and borate compound I or combination of the borate compound I and borate compound II) can be used. In the case where a heat-bleachable layer is provided, a configuration may be used in which heating causes the generation of a base or nucleophilic agent that can bleach the spectral sensitizing dye present therewith.

A layer of a polymer having a low oxygen permeability such as gelatin and polyvinyl alcohol (PVA) may be provided interposed between the support and the photosensitive thermosensitive recording layer. The provision of such a layer makes it possible to effectively inhibit the fading attributed to photooxidation of refractive index-modulated interference fringes.

When a known ordinary photopolymer as disclosed in Patent References 1 to 3 and 5 to 8 is used to effect multiplexed recording, recording in the latter half stage of multiplexed recording is made in a site where polymerization has proceeded considerably. Thus, the latter half stage of multiplexed recording needs more exposure time required to record the same signal than the former half stage of multiplexed recording (that is, the latter half stage of multiplexed recording exhibits a lower sensitivity than the former half stage of multiplexed recording. This phenomenon has been considered a serious problem in die system design. In other words, it has been considered disadvantageous that the range within which the refractive index modulation shows a linear rise with respect to exposure is very narrow.

On the other hand, in accordance with the hologram recording method and material of the invention, the recording of refractive index-modulated interference fringes itself involves the use of color development or color extinction accompanied by no polymerization. Thus, many multiplexed recording jobs can be made. Further, multiplexed recording can be made with the exposure kept constant over all the multiplexed recording jobs, i.e., with a linear rise in refractive index modulation with respect to exposure, making it possible to obtain a wide dynamic range. This is advantageous in that the recording density (capacity) can be raised, the recording system can be simplified and S/N ratio can be enhanced.

Further, the hologram recording method and material of the invention involve fixing and thus are excellent in storage properties and nondestructive reproducibility of recording.

As mentioned above, the hologram recording method and material of the invention provide quite a new recording process that gives basic solution to the aforementioned problems, particularly gives satisfaction of both requirements for higher sensitivity and other properties, including good storage properties, dryability and multiplexed recording properties (higher recording density). The hologram recording method and material of the invention are preferably used particularly for optical recording media (holographic optical memory) and (full-color) 3D display holograms.

In the case where the hologram recording material of the invention is used as an optical recoding medium, the hologram recording material of the invention may have a medium configuration disclosed in JP-A-2004-265472. In this configuration, the system disclosed JP-A-2004-335044 is preferably used to effect recording/reproduction. Alternatively, the system disclosed JP-A-2004-177958 and JP-A-2004-272268 is preferably used to effect recording/reproduction.

Further, the hologram recording material of the invention can be used for optical recording medium and 3D display hologram as well as holographic optical element (HOE, e.g., headup display (HUD) for automobiles, pickup lens for optical disc, head mount display, color filter for liquid crystal, reflective sheet for reflective liquid crystal, lens, diffraction lattice, interference filter, connector for optical fiber, light polarizer for facsimile, building window glass), cover paper for book and magazine, display for POP, gift, and credit card, paper note and wrapping (for security purposes such as forgery prevention) to advantage.

The invention will be further described hereinafter, but the invention is not limited thereto. The term “parts” and “%” as used in the following examples are meant to indicate “parts by mass (parts by weight)” and “% by mass (% by weight)”, respectively.

### EXAMPLE 1

### Example 1

### Preparation and Evaluation of Hologram Recording Material

<Preparation of Electron-Containing Colorless Dye-Containing Microcapsule Solution>

(1-a) Preparation of Electron-Donating Colorless Dye-Containing Microcapsule Solution (I)

8.9 g of the already exemplified yellow color-developable electron-donating colorless dye (L-1) was dissolved in 16.9 g of ethyl acetate. To the solution were then added 20 g of a capsule wall material (trade name: Takenate D-110N, produced by Takeda Pharmaceutical Company Limited.) and 2 g of a capsule wall material (trade name: Millionate MR200, produced by NIPPON POLYURFTHANE INDUSTRY CO., LTD.). The solution thus obtained was added to a mixture of 42 g of 8% phthalated gelatin and 1.4 g of 10% sodium dodecylbenzenesulfonate, and then cmulsiondispersed at a temperature of 20° C. to obtain an emulsion. Subsequently, to the emulsion thus obtained were added 14 g of water and 72 g of a 2.9% aqueous solution of tetraethylene pentamine. The mixture was then heated to 60° C. with stirring for 2 hours to obtain a microcapsule solution (I) having an average particle diameter of 0.2 μm with the aforementioned electron-donating colorless dye (L-1) as core.

(1-b) Preparation of Dissociative Dye Dissociation Product-Containing Microcapsule Solution (II)

The aforementioned method (1-a) was followed except that the already exemplified color-extinguishable dissociative dye dissociation product (G-16) which is a yellow dye was used instead of the electron-donating colorless dye (L-1) used in the aforementioned method (1-a). Thus, a microcapsule solution (II) having an average particle diameter of 0.2 μm with the dissociative dye dissociation product (G-16) as core was obtained.

(1-c) Preparation of Cyanine Base-Containing Microcapsule Solution (III)

The aforementioned method (1-a) was followed except that the already exemplified UV-developable cyanine base (LC-12) was used instead of the electron-donating colorless dye (L-1) used in the aforementioned method (1-a). Thus, a microcapsule solution (III) having an average particle diameter of 0.2 μm with the cyanine base (LC-12) as core was obtained.

<Preparation of Photopolymerizable Composition Emulsion>

(2-a) Preparation of Photopolymerizable Composition Emulsion (1)

5 g of the following electron-donating compound (1) having a polymerizable group was added to a mixture of 0.6 g of the already exemplified organic borate compound (29) (borate compound I), 0.1 g of the already exemplified spectral sensitizing dye-based borate compound (26) (borate compound II), 0.1 g of the following auxiliary (I) for enhancing sensitivity and 3 g of isopropyl acetate (water solubility: about 4.3%). The solution thus obtained was then added to a mixture of 13 g of a 13% aqueous solution of gelatin, 0.8 g of the following 2% aqueous solution of surface active agent (I) and 0.8 g of the following 2% aqueous solution of surface active agent (2). The mixture was then subjected to emulsification at 10,000 rpm using a homogenizer (produced by Nippon Seiki Co., Ltd.) for 5 minutes to obtain a photopolymerizable composition emulsion (1). 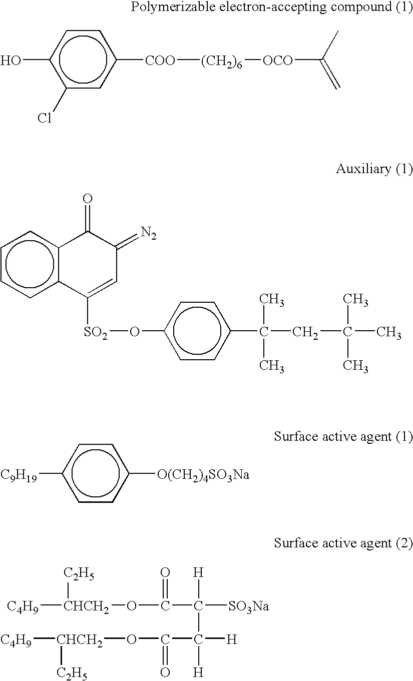
(2-b) Preparation of Photopolymerizable Composition Emulsion (2)

A photopolymerizable composition emulsion (2) was obtained in the same manner as in the method (2-a) except that 0.1 g of the already exemplified spectral sensitizing dye-based borate compound (28) (borate compound II) was used instead of the spectral sensitizing dye-based borate compound (26) used in the method (2-a).

<Preparation of Photosensitive Thermosensitive Recording Layer Coating Solution>

(3-a) Preparation of Photosensitive Thermosensitive Recording Layer Coating Solution (1)—[UV Color Development]

4 g of the cyanine base-containing microcapsule solution (III), 12 g of the photopolymerizable composition emulsion (1) and 12 g of a 15% aqueous solution of gelatin were mixed to prepare a photosensitive thermosensitive recording layer coating solution (1).

(3-b) Preparation of Photosensitive Thermosensitive Recording Layer Coating Solution (2)—[Yellow Color Development]

4 g of the electron-donating colorless dye-containing microcapsule solution (I), 12 g of the photopolymerizable composition emulsion (2) and 12 g of a 15% aqueous solution of gclatin were mixed to prepare a photosensitive thermosensitive recording layer coating solution (2).

(3-c) Preparation of Photosensitive Thermosensitive Recording Layer Coating Solution (3)—[Yellow Color Extinction]

4 g of the dissociative dye dissociation product-containing-microcapsule solution (II), 12 g of the photopolymerizable composition emulsion (2) and 12 g of a 15% aqueous solution of gelatin were mixed to prepare a photosensitive thermosensitive recording layer coating solution (3).

<Preparation of Inventive Photosensitive Thermosensitive Hologram Recording Materials 101 to 103>

The aforementioned photosensitive thermosensitive recording layer coating solution (1) was spread over a cellulose triacetate (TAC) having a thickness of 200 μm to a dried thickness of about 40 μm, and then dried to obtain a photosensitive thermosensitive hologram recording material (101). Similarly, the aforementioned photosensitive thermosensitive recording layer coating solutions (2) and (3) were used to obtain photosensitive thermosensitive hologram recording materials (102) and (103), respectively.

<Preparation of Comparative Example 1>

As a comparative example, a radically polymerizable photopolymer process hologram recording material disclosed in Example 1 of JP-A-6-43634 (Comparative Example 1) was prepared. The hologram recording material thus obtained had a thickness of about 40 μm as in the aforementioned case.

<Evaluation of Hologram Recording>

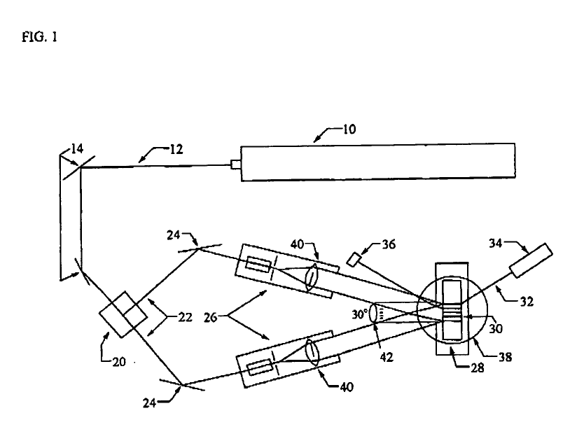

The inventive hologram recording materials (101) to (103) and Comparative Example 1 were each then exposed to YAG laser second harmonic (532 nm; output: 2W) as a light source in a two-flux optical system for transmission hologram recording shown in FIG. 1 to perform recording (first step). The angle of the object light with respect to the reference light was 30 degrees. The light beam had a diameter of 0.6 cm and an intensity of 0.8 mW/cm². During exposure, the holographic exposure time was varied from 0.1 to 200 seconds (radiation energy ranging from 0.08 to 160 mJ/cm²).

The inventive hologram recording materials (101) to (103) which had a latent image formed therein by exposure were each then heated over a 120° C. hot plate for 5 seconds (second step). These hologram recording materials were each then entirely irradiated with light having a wavelength of about 520 nm from a xenon lamp through a band pass filter at a maximum radiation energy of 15 mJ/cm2 on the surface of the recording layer to fix the refractive index-modulated interference fringes (hologram recording) thus formed and extinguish the color of the spectral sensitizing dye (third step).

The hologram recording materials which had been finished up to the third step were each subjected to development, and then measured for diffraction efficiency (relative diffraction efficiency, diffraction light/transmitted light) with only reference light among YAG 532 nm light beams.

The results of evaluation of maximum diffraction efficiency and sensitivity (half the exposure at which maximum diffraction efficiency is given, relative to that of Comparative Example 1 as 100; The less this value is, the higher is sensitivity) of the inventive hologram recording materials 101 to 103 and Comparative Example 1 arc set forth in Table 1.

The evaluation of percent shrinkage are set forth in Table 1. The percent shrinkage was determined by the shift of diffraction wavelength developed when data recorded in the reflective hologram recording material is reproduced.

The maximum diffraction efficiency developed when the hologram recording material is stored under fluorescent lamp for 2 weeks, too, is set forth in Table 1.

TABLE 1

| | | | Diffraction efficiency | |
|---|---|---|---|---|
| | Maximum | | after 2 weeks of | |
| | diffraction | | irradiation with | |
| Sample No. | efficiency | Sensitivity | fluorescent light | Shrinkage |
| 101 | 84% | 60 | 84% | 0.4% |
| 102 | 86% | 50 | 86% | 0.4% |
| 103 | 85% | 52 | 85% | 0.4% |
| Comparative | 81% | 100 | 80% | 5.1% |
| Example 1 | | | | |

As can be seen in Table 1, the known comparative example disclosed in JP-A-643634 exhibits a high diffraction efficiency. However, since the comparative example disclosed in JP-A-6-43634 employs a photopolymer process involving radical polymerization, it undergoes shrinkage as great as more than 5%. The comparative example exhibits an extremely poor S/N ratio and thus is unsuitable for holographic memory use. On the other hand, the hologram recording materials 101 to 103 of the invention employs a recording process which is quite different from that of known hologram recording materials, i.e., hologram recording by refractive index modulation involving color development or color extinction, and thus exhibits a high diffraction efficiency, a percent shrinkage as small as 0.4% and a higher sensitivity than that of known photopolymer process to advantage.

It is also made obvious that the inventive hologram recording materials are excellent, in storage properties and thus are suitable also for not only holographic memory but also 3D display hologram.

Further, the inventive hologram recording materials show a substantially linear rise of Δn (refractive index modulation in interference fringes, calculated from diffraction efficiency and film thickness according to Kugelnick's theoretical equation) depending on the exposure (mJ/cm²) and thus were found to be advantageous in multiplexed recording.

In actuality, the inventive hologram recording materials were each subjected to ten multiplexed hologram recording jobs on the same site at a dose of one tenth of the exposure at which the maximum diffraction efficiency is given with the angle of reference light varied every 2 degrees. The hologram recording materials were each then irradiated with reproducing light with the angle of reproducing light varied every 2 degrees. In this manner, it was confirmed that the respective object light can be reproduced. In other words, it is made obvious that the inventive hologram recording materials allow multiplexed recording at the same exposure and thus are adapted to multiplexed recording. Thus, the inventive hologram recording materials allow many multiplexed recording jobs and hence high density (capacity) recording.

On the other hand, known photopolymer process hologram recording materials, including that of JP-A-6-43634, are found to have a photopolymer to be polymerized excessively in the latter half stage of multiplexed recording, retarding the movement of monomers required for recording and requiring much dose than in the initial stage of multiplexed recording for the same recording. Thus, the known photopolymer process hologram recording materials are found to leave something to be desired in enhancement of multiplexity or recording density.

The same effects were exerted also when the cyanine base to be incorporated in the inventive hologram recording material 101 was changed to LC-1, LC-7, LC-8, LC-9 or LC-11, the electron-donating colorless dye to be incorporated in the hologram recording material 102 was changed to LC-2 or the dissociative dye dissociation product to be incorporated in the hologram recording material 103 was changed to G-4, G-5, G-7 to G-9 or G-14.

While the invention has been described in detail and with reference to specific embodiments thereof, it will be apparent to one skilled in the art that various changes and modifications can be made therein without departing from the spirit and scope thereof.

The entire disclosure of each and every foreign patent application from which the benefit of foreign priority has been claimed in the present application is incorporated herein by reference, as if fully set forth herein.

What is claimed is:

1. A hologram recording method comprising the steps of,
a first step of forming a latent image in a hologram recording material by holographic exposure;
a second step of subjecting the hologram recording material having the latent image to heat treatment so as to form interference fringes providing a refractive index modulation; and
a third step of irradiating the hologram recording material entirely with light to fix the interference fringes,
wherein a hologram recorded by the hologram recording method can be reproduced without erasing the refractive index modulation.

2. The hologram recording method according to claim 1, wherein a light source in the holographic exposure of the first step is a laser.

3. The hologram recording method according to claim 1, wherein a light source in the irradiating of the third step is at least one selected from the group consisting of a laser, an LED, a flash lamp, a fluorescent lamp, a xenon lamp and a mercury vapor lamp.

4. The hologram recording method according to claim 1, wherein the hologram recording material comprises a photopolymerizable composition, the photopolymerzable composition comprising: a photopolymerizable compound having an ethylenically unsaturated bond; and a photopolymerization initiator.

5. The hologram recording method according to claim 1, wherein the hologram recording material comprises a support and a photosensitive and thermosensitive recording layer comprising a photopolymerizable composition, the photopolymerizable composition comprising:
a thermo-responsive microcapsule containing a component A therein, the component A being one of a color-developable component and a color-extinguishable component;
a compound B that is substantially colorless, the compound B comprising, in the same molecule of the compound B, an ethylenically unsaturated bond and a site that reacts with the component A to cause color development or color extinction of the component A; and
a photopolymerizable initiator, and wherein
the photopolymerizable composition is subjected to the holographic exposure at the first step to form the latent image,
the heat treatment at the second step causes color development or color extinction of the component A in accordance with the latent image to form the interference fringes, and
the photosensitive and thermosensitive recording layer is irradiated entirely with light at the third step to decolor the photopolymerization initiator so that the interference fringes are fixed.

6. The hologram recording method according to claim 1, wherein the hologram recording material comprises a support and a photosensitive and thermosensitive recording layer comprising a photopolymerizable composition, the photopolymerizable composition comprising:
a thermo-responsive microcapsule containing a component A therein, the component A being one of a color-developable component and a color-extinguishable component;
a component C that is substantially colorless and reacts with the component A to cause color development or color extinction of the component A;
a compound D comprising, in the same molecule of the compound B, an ethylenically unsaturated bond and a site that inhibits a reaction of the component C with the component A; and
a photopolymerizable initiator, and wherein
the photopolymerizable composition is subjected to the holographic exposure at the first step to form the latent image,
the heat treatment at the second step causes color development or color extinction of the component A in accordance with the latent image to form the interference fringes, and
the photosensitive and thermosensitive recording layer is irradiated entirely with light at the third step to decolor the photopolymerization initiator so that the interference fringes are fixed.

7. The hologram recording method according to claim 4, wherein the photopolymerization initiator comprises: a spectral sensitizing dye having a maximum absorption wavelength of 300 nm to 1,000 nm: and a compound interacting with the spectral sensitizing dye.

8. The hologram recording method according to claim 7, wherein the compound interacting with the spectral sensitizing dye comprises an organic borate compound.

9. The hologram recording method according to claim 7, wherein the spectral sensitizing dye has a molar absorptivity ε of 1 to 500,000 at a wavelength of the holographic exposure.

10. The hologram recording according to claim 1, wherein the hologram recording material comprises a plurality of recording layers undergoing color development or color extinction at different hues from one another.

11. The hologram recording method according to claim 1, wherein the interference fringes are non-rewritable.

12. A hologram recording material comprising: a support; and a hologram recording layer, wherein a hologram is recorded in the hologram recording material by a hologram recording method according to claim 1.

13. The hologram recording method according to claim 1, wherein a multiplexed recording is performed by subjecting the hologram recording material to the holographic exposure ten times or more.

14. The hologram recording method according to claim 13, wherein the multiplexed recording is performed under a common exposure amount in each holographic exposure.

15. An optical recording medium comprising a hologram recording material according to claim 12.

16. The optical recording medium according to claim 15, wherein the hologram recording material is stored in a light-shielding cartridge during storage.

17. The hologram recording method according to claim 1, wherein the hologram recording material is an optical recording medium.

18. The hologram recording method according to claim 5, wherein a longer absorption end of the component A is shorter than a wavelength of the holographic exposure both of before and after the color development or color extinction of the component A.

19. The hologram recording material according to claim 12, which is for a 3D display hologram.

20. The hologram recording method according to claim 1, which is for recording a 3D display hologram.

21. The hologram recording method according to claim 10, which is for recording a full-color 3D display hologram.
